(19) United States
(12) Patent Application Publication
(10) Pub. No.: US 2025/0383534 A1
(43) Pub. Date: Dec. 18, 2025

(54) APPLYING ELECTROMAGNETIC RADIATION TO SAMPLES LOCATED ON A MICROSCOPE STAGE USING A MICROMIRROR ARRAY

(71) Applicants: Steven M. Finkbeiner, San Francisco, CA (US); Jeremy Linsley, San Francisco, CA (US); Kaushik Sridhar, San Francisco, CA (US); Vivek Gopal Ramaswamy, San Francisco, CA (US); Joshua Lamstein, San Francisco, CA (US); Benjamin L. Brumbaugh, San Jose, CA (US); Shijie Wang, San Francisco, CA (US); Drew Linsley, Lakeville, MA (US)

(72) Inventors: Steven M. Finkbeiner, San Francisco, CA (US); Jeremy Linsley, San Francisco, CA (US); Kaushik Sridhar, San Francisco, CA (US); Vivek Gopal Ramaswamy, San Francisco, CA (US); Joshua Lamstein, San Francisco, CA (US); Benjamin L. Brumbaugh, San Jose, CA (US); Shijie Wang, San Francisco, CA (US); Drew Linsley, Lakeville, MA (US)

(21) Appl. No.: 19/242,805

(22) Filed: Jun. 18, 2025

Related U.S. Application Data
(60) Provisional application No. 63/661,516, filed on Jun. 18, 2024.

(51) Int. Cl. G02B 21/00; G02B 21/36

(52) U.S. Cl. CPC G02B 21/0048; G02B 21/008; G02B 21/361; G02B 2207/113

(57) ABSTRACT

The systems and processes described herein can implement experimental protocols that indicate wavelengths of electromagnetic radiation to apply to samples located on a microscope stage and a duration to apply the electromagnetic radiation. Images of the samples can be captured and analyzed to determine a state of the samples.

### CLAIM OF PRIORITY

This patent application claims the benefit of priority to U.S. Provisional Patent Application Ser. No. 63/661,516, filed Jun. 18, 2024, which is incorporated by reference herein in its entirety.

### TECHNOLOGICAL FIELD

The present disclosure relates to implementations of systems and processes to analyze images of biological material captured during electromagnetic radiation being incident upon the biological material. More particularly, the present disclosure relates to systems and processes that can analyze images of a biological cell to determine a state of the biological cell and determine experimental protocols that can modify the state of the biological cell.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Biology has a language of its own. Human development is launched when fertilization brings together a complete instruction set within a single biological cell. That event triggers a series of predictable biological cascades that culminate in the production of the different biological cell types and tissues to make a person. Human disease may begin with and be driven by a genetic event or triggered by an environmental exposure. Subsequently, complex pathogenic and adaptive or maladaptive biological cascades are set in motion that result in signs and symptoms of disease. Significant obstacles have prevented the discovery of the inner workings of complex biological and disease systems with sufficient specificity to reliably predict safe and effective interventions. For example, the sheer number of individual variables and combinations, the time-dependent nature of their effects, and the slow pace of linear hypothesis-driven science has meant that a conventional effort to understand these complex biological systems one variable at a time would require more time than the universe has existed.

### SUMMARY

The following presents a simplified summary of one or more implementations of the present disclosure in order to provide a basic understanding of such implementations. This summary is not an extensive overview of all contemplated implementations and is intended to neither identify key or critical elements of all implementations, nor delineate the scope of any or all implementations.

The systems, processes, and techniques described herein are designed to enable scientists to generate high quality dynamic time series datasets from living biological cells suitable for developing foundation models of biology and disease rapidly and inexpensively. In particular, the systems, processes, and techniques described herein can autonomously design and deliver different perturbations to specified single biological cells in a highly controlled and quantitative manner to expand the range of biological responses available within the dataset for use training foundation models. Further, the systems, processes, and techniques described herein can analyze the results of the perturbations it performs, then update its models of biology with the new information, and then use the updated models to design new perturbations to explore biology further. The system is designed to generate foundation models of biology or disease than can serve as rational blueprints for interventions that shift the fate of biological systems to produce desired outcomes, including the prevention or treatment of disease. The ability of the system to generate perturbations rapidly and in unbiased way and to learn from them and optimize them to produce desired biological responses provides recipes for successful intervention strategies.

In one or more implementations, a method comprises obtaining image data generated by a camera of a microscope. The image data can correspond to an image captured during electromagnetic radiation being incident upon a location of a sample container coupled to the microscope. The electromagnetic radiation can correspond to light from the visible spectrum. The method can also include analyzing, using one or more computational object recognition techniques, the image data to determine a biological cell included in the image. In addition, the method can include analyzing, using a machine learning algorithm, features of the image data corresponding to the biological cell to determine one or more characteristics of the biological cell.

In one or more additional implementations, a method comprises determining an experimental protocol corresponding to one or more biological cells included in a sample container. In addition, the method can comprise determining a location of one or more biological cells in the sample container. Further, the method can comprise determining, using a mapping of an array of mirrors of the microscope to locations of a field of view of a camera of the microscope, a configuration of the array of mirrors that corresponds to the location. The method can also include causing the array of mirrors of the microscope to be conformed to the configuration and causing electromagnetic radiation to be emitted toward the array of mirrors.

In one or more further examples, an apparatus can comprise a microscope including: a stage, one or more cameras, an array of mirrors; and an emitter device that emits electromagnetic radiation. The apparatus can also include a microscope controller. The microscope controller can be configured to determine one or more wavelengths of electromagnetic radiation to apply to a location on a sample container coupled to the stage. The microscope controller can also be configured to cause individual mirrors of the array of mirrors to have a configuration that causes a trajectory of the electromagnetic radiation emitted by the emitter device to be modified to an additional trajectory that corresponds to the location on the sample container.

While multiple implementations are disclosed, still other implementations of the present disclosure will become apparent to those skilled in the art from the following detailed description, which shows and describes illustrative implementations of the invention. As will be realized, the various implementations of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various implementations of the present disclosure, it is believed that the invention will be better understood from the following description taken in conjunction with the accompanying figures. In the figures, the depicted structural elements are not to scale, and certain components may be enlarged relative to the other components for purposes of emphasis and understanding.

FIG. 1 is a diagram of a framework to analyze images obtained by a microscope and to control the operation of the microscope, according to one or more example implementations.

FIG. 2 is a diagram of a framework to direct electromagnetic radiation to a location of a microscope field, according to one or more example implementations.

FIG. 3 is a flow diagram of a process to analyze images obtained by a microscope and to control the operation of the microscope, according to one or more example implementations.

FIG. 4 is a flow diagram of a process to direct electromagnetic radiation to a location of a microscope field, according to one or more example implementations.

FIG. 5 is a block diagram illustrating components of a machine, in the form of a computer system, that may read and execute instructions from one or more machine-readable media to perform any one or more methodologies described herein, in accordance with one or more example implementations.

FIG. 6 is a block diagram illustrating a representative software architecture that may be used in conjunction with one or more hardware architectures described herein, in accordance with one or more example implementations.

FIG. 7 includes a graph and an image showing that one cell can be autonomously stimulated differently and independently of its neighbor and produce dose-dependent biological perturbations.

FIG. 8 shows a number of diverse biological structures that confer sensitivity to light.

FIG. 9 shows examples of some types of light-inducible biochemistry enabled by synthetic fusion proteins.

FIG. 10 shows an example process of optogenetic control of gene transcription and genetic engineering.

FIG. 11 shows an example process of optogenetic control of immunomodulation.

FIG. 12 shows Precise optogenetic control of biology resulting in individual primary cortical neurons expressing miniSOG2-T2a-RGEDI-P2a-EGFP were tracked and either left unstimulated (left) or stimulated with blue light of various durations (right). Blue light stimulates miniSOG to produce oxygen free radicals, leading to neuronal death as measured with RGEDI. Blue light stimulation; EGFP; RGEDI.

FIG. 13 shows controlling synapse formation. Left graphic, synapses visualized with hSyn1: synaptophysin-mRuby (upper left quadrant); neurons visualized with hSyn1: ChR2-EGFP (upper right quadrant); blue light stimulation (lower left quadrant; overlay of the three different fluorescent channels (lower right quadrant). Right graphic, Time-dependent increase in the fluorescence of the synapse marker, synaptophysin-mRuby, in stimulated cells.

FIG. 14 shows a cascade of TDP-43 mislocalization, loss of function, and neurodegeneration recapitulated in relation to electromagnetic radiation being applied to neurons.

FIG. 15 shows an example of closed loop microscopy with implementations described herein. A) HEK cells expressing the photoswitchable protein, Eos4.2. B) Closed loop cycle of the implementations described herein in which the decision whether to stimulate a given cell is made by the computer after it observes the fluorescence intensity of the cell. C) Schematic depiction of an experiment in which the computer is instructed to identify the brightest 50% of cells and then stimulate them in a closed loop resulting in increasing red signal in the stimulated cells and no change in the remaining unstimulated cells. D) Quantification of HEK cell RFP/GPF intensity. E) The computer was then reprogrammed to identify the 50% of the dimmest cells and selectively stimulate them in closed loop resulting in gradual conversion of all cells. F) Quantification of HEK cell RFP/GFP intensity.

### DETAILED DESCRIPTION

The present disclosure, in one or more implementations, relates to systems and processes that have the ability to identify and track individual live biological cells, monitoring them repeatedly, over intervals of minutes to months in high throughput. Fluorescent biosensors have been developed to visualize diverse structures and functions dynamically in living biological cells. These features provide the foundation for generating time-series datasets to record the cascade of events underlying biology or disease and to create corresponding foundation models.

Systems, processes, and techniques described herein have the capability to perform experiments (e.g., perturbations) autonomously under computer control by the platform. The perturbations are designed by the platform and tailored to each biological cell. To start, the perturbations are varied from biological cell to biological cell to discover a broad range of stimulus-response relationships. Subsequently, the system observes the effect of its perturbations, and uses the information and reinforcement learning to update and expand the foundation model it has created. Based on the updated model, it then designs new perturbations and repeats the process iteratively. The experiment ends when the contours of the biological landscape have been determined with the desired granularity or when a blueprint of perturbation has been discovered that guides the adaptive responses of a biological cell to a desired goal, such as making a “sick” biological cell into a “healthy” one.

The systems, processes, and techniques described herein can mitigate two of the biggest challenges to the production of biological datasets suited for training foundation models-cost and batch variation. The systems, processes, and techniques described herein significantly reduce the expense of generating adequate datasets because it miniaturizes each experiment to a single biological cell. The systems, processes, and techniques described herein can also reduce the time required to generate adequate datasets by massively parallelizing and accelerating data collection. Myriad stimulation paradigms are tested simultaneously, analysis is performed in real time to develop and update computational models of biology, and then the next round of stimuli are designed and applied without ever needing to remove the biological sample from the system. The design of the system also helps reduce batch variation. One biological cell can be perturbed or left unperturbed independently of the perturbation applied to neighboring biological cell. Thus, we can design stimulation paradigms for each biological cell in a well that produce highly controlled set of single biological cell data from the same well.

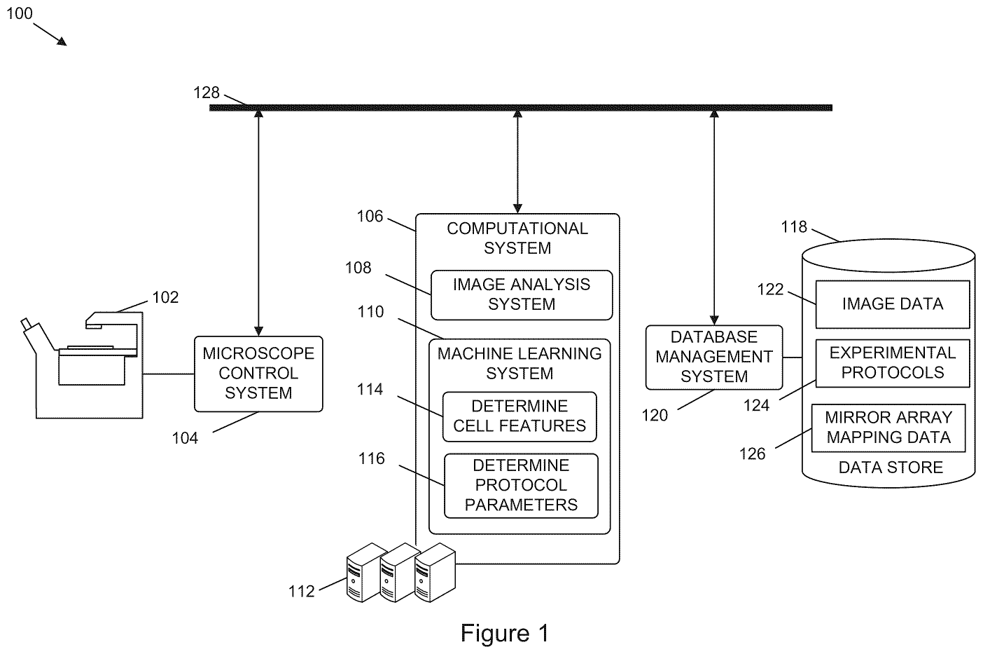

FIG. 1 is a diagram of a framework 100 to analyze images obtained by a microscope 102 and to control the operation of the microscope 102, according to one or more example implementations. In one or more examples, the microscope 102 can include an inverted microscope. The microscope 102 can include a number of components that enable viewing of biological material. In one or more examples, a sample can be provided to the microscope 102 that includes the biological material. In various examples, the sample can include a liquid solution that includes one or more biological cells. The one or more biological cells can include at least one of prokaryotic biological cells or eukaryotic biological cells. In one or more additional examples, the sample can include a tissue sample. In one or more illustrative examples, the microscope 102 can include features of the microscopes described in U.S. Pat. No. 7,139,415, issued Nov. 21, 2006, and entitled “Robotic Microscopy Systems”; U.S. Pat. No. 10,474,920, issued Nov. 12, 2019, and entitled “Automated Robotic Microscopy Systems”; and in U.S. Pat. No. 11,361,527, issued Jun. 14, 2022, and entitled “Automated Robotic Microscopy Systems”, each of which is incorporated by reference herein in their entirety.

The microscope 102 can include a stage that secures a container that includes the sample. In one or more examples, the container can include a slide. In one or more additional examples, the container can include a plate. In one or more further examples, the container can include a dish. In one or more illustrative examples, the container can include a plate having a number of wells. In these scenarios, the container can include a multi-well plate that can hold a plurality of samples.

Additionally, the microscope 102 can include a number of objectives and an eyepiece. The objectives and the eyepiece can operate to magnify one or more samples or one or more portions of samples. The microscope 102 can include one or more cameras to capture images of samples or portions of samples. Further, the microscope 102 can include a light source to illuminate samples located on the stage. In still other examples, the microscope 102 can include an emitting device. The emitting device can emit electromagnetic radiation that is directed to one or more locations of a sample container. The electromagnetic radiation emitted by the emitting device can be provided to determine whether or not samples upon which the electromagnetic radiation is incident are impacted by being contacted by the electromagnetic radiation.

In various examples, the microscope 102 can include one or more filters that cause electromagnetic radiation having specified wavelength ranges to be incident on one or more locations of the sample container. For example, the microscope 102 can include a first filter that causes electromagnetic radiation having wavelengths from about 300 nanometers (nm) to about 400 nm, and generally corresponds to purple light, to be incident on one or more locations of a sample container. In addition, the microscope 102 can include a second filter that causes electromagnetic radiation having wavelengths from about 400 nm to about 500 nm, and generally corresponds to blue light, to be incident on one or more locations of a sample container. Further, the microscope 102 can include a third filter that causes electromagnetic radiation having wavelengths from about 500 nm to about 600 nm, and generally corresponds to green light, to be incident on one or more locations of a sample container. In still other examples, the microscope 102 can include a fourth filter that causes electromagnetic radiation having wavelengths from about 600 nm to about 700 nm, and generally corresponds to red light, to be incident upon one or more locations of a sample container. In at least some examples, the microscope 102 can include a fifth filter that causes electromagnetic radiation having wavelengths from about 1 micrometer (μm) to about 100 μm, and generally corresponds to infrared radiation, to be incident on one or more locations of a sample container. The number of filters and ranges of wavelengths corresponding to the respective filters described in this paragraph are illustrative examples. In one or more additional implementations, the microscope 102 can include fewer filters or a greater number of filters. Further, the wavelength ranges corresponding to each filter can be associated with broader wavelength ranges or narrower wavelength ranges.

The microscope 102 can include or be coupled to a microscope control system 104. The microscope control system 104 can cause a number of operations to be performed in relation to the microscope 102. In at least some examples, the microscope control system 104 can include at least one of processing resources or memory resources that can be used to execute code related to controlling one or more operations of the microscope. In still other examples, the microscope control system 104 can include circuitry that enables the processing of signals directed to one or more operations being performed by the microscope 102. In various examples, the microscope control system 104 can provide instructions, commands, and the like to devices that are coupled to, or otherwise associated with, the microscope 102, such as a robotic device that can operate to load and unload sample containers from the microscope 102.

In one or more examples, the microscope control system 104 can performed, in response to input obtained from a user of the microscope 102. For example, a user of the microscope 102 can provide input via an input device, such as touch input, audio input, image input, or video input. In one or more illustrative examples, the microscope 102 can include or be coupled to one or more input devices, such as one or more touchscreens, one or more buttons, a keyboard, a mouse, a touchpad, a trackball, a joystick, one or more motion sensors, one or more microphones, one or more additional cameras, one or more combinations thereof, and so forth.

The microscope control system 104 can also obtain input from one or more additional computing devices. For example, one or more operations performed in relation to the microscope 102 can be executed based on input obtained via a mobile computing device, a tablet computing device, a laptop computing device, or a desktop computing device coupled to the microscope control system 104. In various examples, the microscope control system 104 can obtain input from an application executing on an external computing device. In one or more additional examples, the microscope control system 104 can obtain at least one of instructions or experimental protocols from a computational analysis system 106. The computational analysis system 106 can execute one or more machine learning models that can generate at least one of instructions or experimental protocols that are executed by the microscope control system 104 to cause the microscope 102 to direct electromagnetic magnetic radiation to one or more locations of a sample container.

In one or more illustrative examples, the microscope control system 104 can cause loading and unloading of one or more sample containers onto the stage of the microscope 102. The microscope control system 104 can also cause movement of a sample container that is located on the stage of the microscope 102. Additionally, the microscope control system 104 can cause adjustment of at least one of an eyepiece of the microscope 102 or one or more objectives of the microscope 102 to provide a specified level of magnification for viewing one or more samples and/or one or more portions of samples.

In various examples, the microscope control system 104 can cause images to be captured of one or more portions of a sample container. In situations where a multi-well plate is located on the stage of the microscope 102, the microscope control system 104 can cause a camera of the microscope 102 to capture images of one or more wells of the multi-well plate. In one or more examples, the microscope control system 104 can capture images of one or more locations of a sample container at one or more time intervals. The microscope control system 104 can also capture images of one or more locations of a sample container according to one or more parameters of the camera of the microscope 102. The parameters of the camera of the microscope 102 can include frame rate, resolution settings, shutter settings, exposure settings, gain settings, light settings, noise reduction settings, one or more combinations thereof, and so forth.

Additionally, the microscope control system 104 can cause one or more wavelengths of electromagnetic radiation to be incident on one or more locations of a sample container. In one or more examples, the microscope control system 104 can cause one or more filters to be applied to electromagnetic radiation provided by an emitting device to generate electromagnetic radiation having one or more specified wavelengths. The microscope control system 104 can also cause electromagnetic radiation having one or more wavelengths to be incident on one or more locations of a sample container for a specified duration. In various examples, the wavelengths of electromagnetic radiation and the time that the electromagnetic radiation is incident on one or more locations of a sample container can correspond to one or more experimental protocols. The one or more experimental protocols can be obtained via user input. Further the one or more experimental protocols can be generated by one or more machine learning models. In at least some examples, the one or more experimental protocols can include parameters that are intended to determine whether or not biological material included in one or more samples undergoes changes in response to the applied electromagnetic radiation. The one or more experimental protocols can also include parameters that are intended to identify characteristics of biological material included in one or more samples based on changes that occur to the biological material in response to being contacted by electromagnetic radiation according to the one or more protocols. In still other examples, the microscope control system 104 can operate one or more cameras in conjunction with an experimental protocol. For example, the microscope control system 104 can cause one or more images of a location of a sample container to be captured during exposure of the location to electromagnetic radiation that corresponds to the experimental protocols.

Further, the microscope 102 can include a micromirror array that is controlled by the microscope control system 104. In one or more examples, the micromirror array can include a number of mirrors that can be independently controlled. For example, individual mirrors of the micromirror array can have a specified tilt angle and/or a specified rotation angle. By controlling at least one of a tilt angle or a rotation angle of the individual micromirrors, the location of the incident electromagnetic radiation can be controlled. In one or more illustrative examples, the microscope control system 104 can determine a location of a sample container on which electromagnetic radiation is to be applied and configure individual mirrors of the micromirror array such that the emitted electromagnetic radiation is incident upon the location.

The computational system 106 can include an image analysis system 108 and a machine learning system 110. The computational system 106 can be implemented by one or more computing devices 112. The one or more computing devices 112 can include one or more server computing devices, one or more desktop computing devices, one or more laptop computing devices, one or more tablet computing devices, one or more mobile computing devices, or combinations thereof. In one or more implementations, at least a portion of the one or more computing devices 112 can be implemented in a distributed computing environment. For example, at least a portion of the one or more computing devices 112 can be implemented in a cloud computing architecture.

The image analysis system 108 can perform one or more operations in relation to images captured by the microscope 102. For example, the image analysis system 108 can implement one or more image processing techniques to identify one or more objects included in an image captured by the microscope 102. In one or more examples, the image analysis system 108 can implement one or more background subtraction algorithms to identify one or more objects included in an image captured by the microscope 102. In one or more illustrative examples, the image analysis system 108 can implement one or more background subtraction algorithms in relation to a series of images captured by a camera of the microscope 102. In various examples, the series of images for which the image analysis system 108 implements the one or more background subtraction algorithms can include frames of video captured by one or more cameras of the microscope 102. In at least some examples, the one or more background subtraction algorithms can include Running Gaussian average, temporal media filter, mixture of Gaussians, kernel density estimation, sequential kernel density approximation, co-occurrence of image variations, Eigen-backgrounds, one or more combinations thereof, and the like.

Additionally, the image analysis system 108 can implement one or more image segmentation techniques to identify one or more objects in one or more images captured by one or more cameras of the microscope 102. The one or more image segmentation techniques can generate groups of pixels on which object recognition can be performed. In one or more illustrative examples, one or more pixel grouping techniques that can be implemented as part of image segmentation operations can include hierarchical agglomerative clustering, k-means clustering, and mean shift. The one or more image segmentation techniques can also include one or more edge-based segmentation techniques and/or one or more region-based segmentation techniques. In one or more further examples, the image analysis system 108 can implement one or more thresholding techniques to perform image segmentation in relation to object detection. In still other examples, one or more convolutional neural networks can be implemented to perform image segmentation with respect to one or more images captured by one or more cameras of the microscope 102. In at least some examples, the image analysis system 108 can implement a U-Net architecture to identify one or more objects included in one or more images captured by one or more cameras of the microscope 102.

In various examples, the image analysis system 108 can generate one or more image masks based on the image segmentation operations. In one or more examples, the image masks can correspond to an object of interest. For example, the image masks can correspond to one or more biological cells within an image. In at least some examples, the image masks can correspond to an individual biological cell. In one or more illustrative examples, the image masks can be assigned an identifier that corresponds to the biological cell related to a given image mask. The image masks can be used to track a biological cell over time as the biological cell is subjected to one or more doses of electromagnetic radiation according to one or more experimental protocols. In one or more additional illustrative examples, characteristics of the biological cells can be determined using the image masks and the characteristics can be tracked over time. The characteristics of the biological cells can include morphological features of the biological cells. Additionally, the characteristics of the biological cells determined using the image masks can include measures of fluorescence signals from biosensors or channels in the biological cells represented by the image masks. Changes to these characteristics can be tracked over time and can serve as input to machine learning algorithms that can be used to determine additional stimuli for the biological cells.

Further, the image analysis system 108 can perform one or more object tracking operations. In one or more examples, the object tracking operations performed by the image analysis system 108 can be performed in relation to one or more biological cells present in one or more images captured by one or more cameras of the microscope. In one or more illustrative examples, the image analysis system 108 can perform object tacking using one or more centroid tracking algorithms that calculate the center-of-mass (centroid) of the object of interest. In one or more additional illustrative examples, the image analysis system 108 can perform object tracking by implementing one or more Gaussian mixture models. In one or more further illustrative examples, the image analysis system 108 can perform object tracking by implementing one or more cross-correlation algorithms that can compare an image to a matrix of pixels of a successive image. In still other examples, the image analysis system 108 can perform one or more object tracking operations by implementing at least one of a kernelized correlation filter algorithm or a channel and spatial reliability tracker algorithm.

The machine learning system 110 can implement one or more machine learning models to analyze images captured by one or more cameras of the microscope 102. In one or more examples, the machine learning system 110 can implement the one or more machine learning models using information generated by the image analysis system 108. For example, the machine learning system 110 can analyze biological cells identified by the image analysis system 108. To illustrate, the machine learning system 110 can, at 114, determine biological cell features based on data obtained from the image analysis system 108. In one or more examples, the machine learning system 110 can determine biological cell features that can differentiate a number of biological cells from one another and/or determine biological cell features that can indicate that a number of biological cells have the same or similar characteristics In various examples, the machine learning system 110 can determine labels for biological cells that correspond to feature sets for the biological cells. In at least some examples, the machine learning system 110 can implement one or more machine learning algorithms to generate multidimensional/latent space definitions of features that are most likely to distinguish biological cells from one another. In one or more illustrative examples, the machine learning system 110 can determine features of biological cells that can be used to differentiate cells obtained from subjects in which a biological condition is present from cells obtained from subjects in which a biological condition is not detected. In at least some examples, biological condition can correspond to one or more diseases. In one or more additional examples, the biological condition can correspond to one or more biological processes being active or inactive with respect to a patient from which the biological cell is obtained.

In various examples, the machine learning system 110 can implement a machine learning model to make a determination whether one or more images of a biological cell correspond to a biological cell state. In one or more examples, the machine learning model can be trained using images of biological cells that correspond to a specified state. In one or more additional examples, the machine learning model can be trained using images of biological cells that do not correspond to the specified state. Through the training process, the machine learning model can determine characteristics of images of biological cells that are indicative of one or more biological cell states. In at least some examples, the machine learning system 110 can implement one or more deep learning models to determine a state of a biological cell included in one or more images captured by one or more cameras of the microscope 102.

The machine learning system 110 can also, at 116, determine protocol parameters. The protocol parameters can be related to experiments performed with respect to biological material included in samples located in a container on the microscope 102. In one or more examples, the protocol parameters can correspond to one or more wavelengths of electromagnetic radiation that is to be incident on at least a portion of a sample located in a container on the microscope 102. In one or more illustrative examples, the protocol parameters can correspond to a range of wavelengths that are to be incident on at least a portion of a sample located in a container on the microscope 102. In at least some example, a range of wavelengths specified in a protocol can correspond to a color of visible light. Additionally, the protocol parameters can include durations that electromagnetic radiation is to be incident on one or more locations of a sample container. In one or more further examples, the protocol parameters can indicate one or more intensities of electromagnetic radiation that is to be incident on one or more locations of a sample container.

In various examples, a first set of protocol parameters can indicate that a first range of wavelengths is to be applied to a first location of a sample container for a first period of time and at one or more first intensities. In addition, a second set of protocol parameters can indicate that a second range of wavelengths is to be applied to a second location of a sample container for a second period of time at one or more second intensities. In one or more illustrative examples, the first set of protocol parameters can be applied concurrently with respect to the second set of protocol parameters. In still other examples, the first set of protocol parameters can be applied simultaneously or substantially simultaneously with respect to the second set of protocol parameters. In one or more additional illustrative examples, the first set of protocol parameters can be the same or substantially the same as the second set of protocol parameters. In one or more further illustrative examples, one or more values for at least one parameter of the first set of parameters are different from one or more values for a corresponding parameter of the second set of parameters.

The machine learning system 110 can, at 116, analyze previous sets of protocol parameters to determine one or more new sets of protocol parameters. In one or more examples, the machine learning system 110 can implement machine learning algorithms that can form foundational models that can be used to modify experimental protocol parameters. In one or more examples, the machine learning algorithms can be based on the biological landscape being studied. In various examples, the machine learning algorithms used to determine experimental protocol modifications and/or to determine new experimental protocols can be developed and refined over time as the features of the data being studied for a particular biological landscape become clearer and the types of machine learning algorithms that are best suited to efficiently and accurately analyzing the data for the particular biological landscape become apparent. Some examples of machine learning algorithms that can be used to analyze data generated from experimental protocols and make modifications to the experimental protocols can include reinforcement learning algorithms, machine learning diffusion models, large language models, machine vision models, transformer-based machine learning models, encoder and decoder machine learning architectures, one or more combinations thereof, and so forth.

In one or more illustrative examples, one or more reinforcement machine learning algorithms can analyze previous sets of protocol parameters to determine one or more additional sets of protocol parameters. In one or more illustrative examples, the machine learning system 110 can implement one or more model free reinforcement machine learning algorithms. In one or more additional illustrative examples, the machine learning system 110 can implement one or more on-policy reinforcement learning algorithms. In one or more further illustrative examples, the machine learning system 110 can implement one or more off-policy reinforcement learning algorithms. In one or more examples, the reinforcement learning algorithms can implement scalar values that correspond to rewards that a computational agent attempts to obtain. The rewards can correspond to different states or features related to the biological cells. The reinforcement learning algorithms can, for each perturbation of a biological cell, receive an observation related to the perturbation, such as via a biosensor or morphological data, and receive a reward. The reinforcement learning algorithms can also take into account the environment related to the biological cells. In at least some examples, the reinforcement learning algorithms can implement a Markov process to represent the most useful information from a history of observations. The reinforcement learning algorithms can also generate a state transition matrix that can be updated. The reinforcement learning algorithms can determine next perturbations to make with respect to a biological cell based on movement within the state transition matrix to obtain a given reward.

In at least some examples, the functionality of the computational system 106 can be modular. That is, software code corresponding to different functionalities can be added and/or replaced as needed. For example, a software module including code for a first object segmentation algorithm can be replaced by providing code for a second object segmentation algorithm. Additionally, deep learning model or other machine learning model functionality can be replaced by different machine learning functionality depending on the biological environments being studied at a given time.

The framework 100 can also include a data store 118. The data store 118 can store data generated by the microscope 102. The data store 118 can also store data used to control the microscope 102. In one or more illustrative examples, the data store 118 can store information in one or more objects. In one or more additional illustrative examples, the data store 118 can store objects in tables. In one or more further illustrative examples, the data store 118 can include a relational database. In at least some examples, the data store 118 can operate as a PostgreSQL database.

The data store 118 can include or otherwise be in electronic communication with a database management system 120. The database management system 120 can control access to information stored by the data store 118. For example, the database management system 120 can receive requests to read information stored by objects of the data store, retrieve the requested information, and make the retrieved information accessible to the requesting device. Additionally, the database management system 120 can receive requests to modify information stored by the data store 118. To illustrate, the database management system 120 can receive input to make changes to information stored by the data store 118 can cause the requested changes to be implemented within one or more objects of the data store 118. The database management system 120 can also add new data to the data store 118.

In one or more examples, the data store 118 can store image data 122. The image data 122 can include images captured by one or more cameras of the microscope 102. In at least some examples, the image data 122 can include images captured by one or more cameras of one or more additional microscopes. In one or more illustrative examples, the image data 122 can include tiles. The tiles can correspond to entire images. The tiles can also correspond to one or more objects included in an image. For example, the image data 122 can include tiles that correspond to one or more biological cells that are included in an image. In at least some examples, an individual tile included in the image data 122 can correspond to an individual biological cell included in an image. In various examples, the image data 122 can indicate an identifier for individual images and/or an identifier for an individual tile included in the image data 122. An identifier for an image or a tile can uniquely identify the image or the tile. In one or more additional examples, at least one of the tiles or images for a given experiment can be stored in a table that corresponds to the given experiment.

The data store 118 can also store experimental protocols 124. The experimental protocols 124 can indicate parameters for the microscope 102 that were applied when images were captured by the microscope 102. For example, the experimental protocols 124 can indicate one or more wavelengths of electromagnetic radiation applied by the microscope 102 during the capture of one or more images by the microscope 102. Additionally, the experimental protocols 124 can indicate a duration that electromagnetic radiation was applied by the microscope 102 during the capture of one or more images by the microscope 102. Further, the experimental protocols 124 can indicate one or more intensities of electromagnetic radiation applied by the microscope 102 during the capture of the one or more images by the microscope 102. The experimental protocols 124 can also indicate a location of a sample container to which electromagnetic radiation was applied during the capture of one or more images by the microscope 102. In one or more illustrative examples, the experimental protocols 124 can indicate one or more biological cells to which electromagnetic radiation was applied during the capture of one or more images by the microscope 102. In one or more additional illustrative examples, the experimental protocols 124 can indicate biological cells that can act as control cells. The control cells may not receive the same perturbations as biological cells being studied.

Although experimental protocols are described herein as involving perturbations using electromagnetic radiation, in other examples, perturbations of biological cells can correspond to electrical stimulation of the biological cells and/or delivering treatment molecules to the biological cells. In addition, the experimental protocols 124 can indicate results of the experimental protocols. The results of the experimental protocols 124 can indicate morphology of the biological cells in response to perturbations. Further, the results of the experimental protocols 124 can indicate indicators provided by biosensors, such as fluorescence, in relation to perturbations of the biological cells.

The data store 118 can also store mirror array mapping data 126. The mirror array mapping data 126 can indicate configurations of a mirror array of the microscope 102 that cause electromagnetic radiation to be incident on a location of a sample container. In one or more examples, the mirror array mapping data 126 can be based on a size of the sample container. In one or more additional examples, the mirror array mapping data 126 can be based on a size of wells of the sample container. In at least some examples, images captured by the microscope 102 can be used to determine a configuration of a mirror array of the microscope 102 that causes electromagnetic radiation to be incident on a given location of a sample container. In one or more additional examples, one or more photosensors can be used to determine a configuration of a mirror array of the microscope 102 that causes electromagnetic radiation to be incident on a given location of a sample container. In various examples, the mirror array mapping data 126 can be determined for individual sample containers using a calibration process. After a mapping has been determined for the mirror array with respect to a given sample container, the mapping can be re-used when the sample container is coupled to the microscope 102. In at least some examples, the mapping can indicate configurations of the mirror array of the microscope 102 that correspond to locations of a field of view of a camera of the microscope 102. In one or more illustrative examples, the mapping can indicate configurations of the mirror array and/or one or more mirrors of the mirror array that correspond to one or more pixels of the field of view of the camera of the microscope 102.

In one or more examples, the framework 100 can include a communications channel 128. The communications channel 128 can be configured to enable data to be sent between the microscope control system 104, the computational system 106, and the database management system 120. In various examples, data can be communicated between the microscope control system 104, the computational system 106, and the database management system 120 via at least one of a local area wireless communications network, a local area wired communications network, or a wide area wireless communications network. In one or more illustrative examples, the microscope control system 104, the computational system 106, and the database management system 120 can send messages on the communications channel 128. In at least some examples, the microscope control system 104, the computational system 106, and the database management system 120 can subscribe to the communications channel 128. In these scenarios, devices subscribed to the communications channel 128 can be notified of messages sent by the other devices subscribed to the communications channel 128. For example, the computational system 106 can be notified in response to an image being sent from the microscope 102 to the data store 118. In one or more illustrative examples, the microscope control system 104 can generate a message that includes an identifier of the image being sent from the microscope 102 to the data store 118. In one or more additional illustrative examples, the computational system 106 can access the message and use the identifier included in the message to retrieve the payload corresponding to an image from the data store 118 by sending a request to the database management system 120.

In one or more further illustrative examples, messages can be provided to the communications channel 128 by the database management system 120 in response to modifications to data stored by the data store 118. In still other examples, messages can be provided to the communications channel 128 by the computational system 106 in response to at least one of the image analysis systems 108 performing one or more image analysis operations or the machine learning system 110 determining one or more biological cell features and/or determining one or more experimental protocol parameters. In one or more illustrative implementations, the computational system 106 can provide a message to the communications channel 128 in response to determining modifications to a previous experimental protocol.

During operation, the microscope control system 104 can determine an experimental protocol with respect to a biological cell included in a sample container coupled to the microscope 102. In one or more examples, the experimental protocol can be determined based on at least one input obtained from a user of the microscope 102, based on the experimental protocols 124 stored by the data store 118, or based on experimental protocol parameters generated by the computational system 106.

The microscope control system 104 can cause components of the microscope 102 to implement the experimental protocol. For example, the microscope control system 104 can determine that the experimental protocol indicates that one or more wavelengths of electromagnetic radiation are to be applied to a biological cell included in a sample container coupled to the microscope 102. In one or more examples, the microscope control system 104 can determine an arrangement of one or more filters of the microscope 102 to produce the one or more wavelengths of electromagnetic radiation specified by the experimental protocol. The microscope control system 104 can then cause the one or more filters of the microscope 102 to correspond to the arrangement of filters that corresponds to the one or more wavelengths of the experimental protocol.

In addition, the microscope control system 104 can determine a location of the biological cell within the sample container. In one or more illustrative examples, the biological cell can be associated with an identifier and the microscope control system 104 can query the database management system 120 to retrieve the location of the biological cell. Based on the location of the biological cell, the microscope control system 104 can determine a configuration of a micromirror array to cause electromagnetic radiation emitted by the microscope 102 to be incident upon the location of the biological cell. In various examples, the microscope control system 104 can analyze the mirror array mapping data 126 to determine a mapping of the configuration of the micromirror array to the location of the biological cell. In one or more additional illustrative examples, the microscope control system 104 can determine at least one of a pitch of one or more mirrors of the micromirror array of the microscope 102, a tilt of one or more mirrors of the micromirror array of the microscope 102, or an angle of rotation of one or more mirrors of the micromirror array of the microscope 102. The microscope control system 104 can then cause the mirrors of the micromirror array to correspond to the configuration that corresponds to the location of the biological cell. The microscope control system 104 can also determine an intensity of electromagnetic radiation to be applied to the biological cell and a duration that the electromagnetic radiation is to be incident on the biological cell.

After determining parameters of the experimental protocol and configuring the components of the microscope 102 to correspond to parameters of the experimental protocol, the microscope control system 104 can cause electromagnetic radiation to be emitted from one or more emitting devices of the microscope 102. The microscope control system 104 can also cause one or more images to be captured of the biological cell at one or more times during the electromagnetic radiation being incident on the biological cell. The one or more images can be stored as a portion of the image data 122 and analyzed by the computational system 106.

In one or more examples, the experimental protocol can indicate that a number of cycles of applying electromagnetic radiation to the biological cell are to be performed. In various examples, at least a portion of the parameters of the experimental protocol can be different for one or more cycles of the experimental protocol. For example, at least one of wavelengths of electromagnetic radiation, duration of electromagnetic radiation being incident upon the biological cell, or intensity of electromagnetic radiation being incident on the biological cell can be different in relation to a number of cycles of the experimental protocol. In one or more additional examples, at least a portion of the parameters of the experimental protocol can be the same in relation to a number of cycles of the experimental protocol. To illustrate, at least one of wavelengths of electromagnetic radiation, duration of electromagnetic radiation being incident upon the biological cell, or intensity of electromagnetic radiation being incident on the biological cell can be the same in relation to a number of cycles of the experimental protocol. In one or more further examples, the experimental protocol can include an order in which to perform a number of cycles of the experimental protocol.

In one or more illustrative examples, performing a plurality of cycles of the experimental protocol with respect to the biological cell can enable the computational system 106 to generate a latent space representation that corresponds to characteristics of the biological cell in response to different wavelengths of electromagnetic radiation, different amounts of exposure to electromagnetic radiation, and/or different intensities of electromagnetic radiation incident upon the biological cell. In at least some examples, the computational analysis system 106 can analyze the latent space to determine one or more modifications to electromagnetic radiation applied to the biological cell that are predicted to cause changes to one or more characteristics of the biological cell. In various illustrative examples, the computational system 106 can determine modifications to an experimental protocol that can cause the biological cell to move from a diseased state to a state that is free of disease. In still other illustrative examples, the computational system 106 can determine modifications to an experimental protocol that cause the biological cell to move from an active state to an inactive state. In this way, predictions generated by the computational system 106 by implementing one or more reinforcement learning techniques can be used to determine experimental protocol modifications that can then be implemented by the microscope control system 104. The microscope control system 104 can then capture images of the biological cell during a time when the modified experimental protocol is applied to the biological cell and the computational system 106 can, subsequently, analyze the images to determine additional changes to the experimental protocol. As a result, a feedback loop can be implemented that refines the learning performed by the computational system 106 and provides a greater probability of the biological cell having one or more target characteristics.

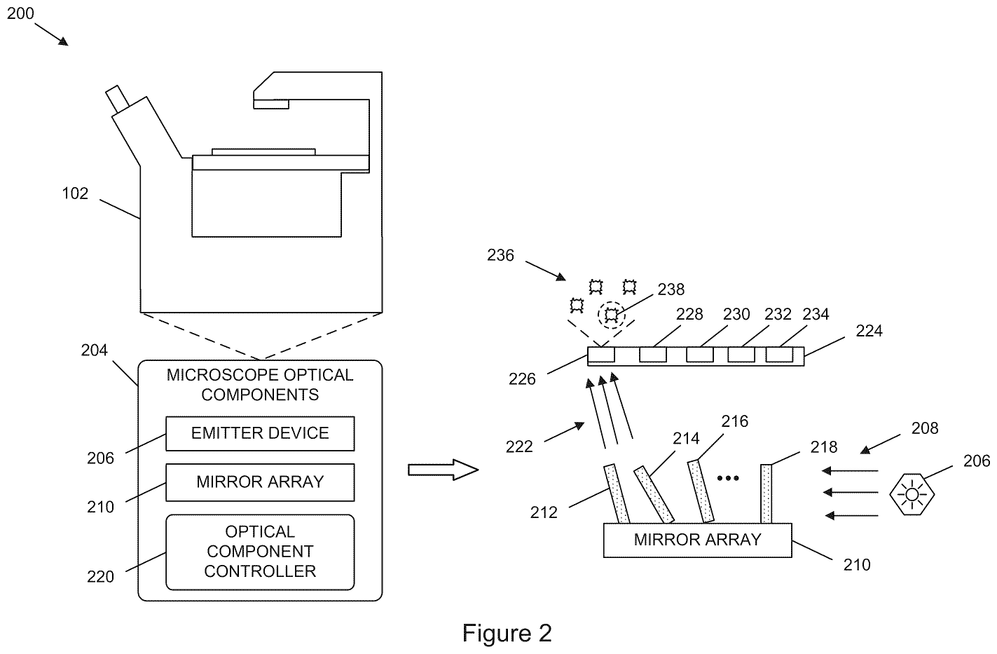

FIG. 2 is a diagram of a framework 200 to direct electromagnetic radiation to a location of a microscope field, according to one or more example implementations. The framework 200 can include a microscope 102. The microscope 102 can include a number of microscope optical components 204. The microscope optical components 204 can operate to control the application of electromagnetic radiation to biological material located in a sample container that is coupled to a stage of the microscope 102. In various examples, the sample container can include a plate having a number of wells.

The microscope optical components 204 can include an emitter device 206. The emitter device 206 can emit electromagnetic radiation 208. The emitter device 206 can also include a number of filters. The filters and the emitter device 206 can operate to cause the electromagnetic radiation 208 to have one or more specified wavelengths to be emitted by the emitter device 206. In one or more examples, the emitter device 206 can emit the electromagnetic radiation 208 having wavelengths that correspond to the visible light portion of the electromagnetic spectrum.

The microscope optical components 204 can also include a mirror array 210. The mirror array 210 can include a number of individual mirrors. For example, the mirror array 210 can include a first mirror 212, a second mirror 214, a third mirror 216, up to an Nth mirror 218. The mirrors 212, 214, 216, 218 of the mirror array 210 can have dimensions on the order of micrometers and/or millimeters. To illustrate, the mirrors 212, 214, 216, 218 can have dimensions from about 10 micrometers to about 10,000 micrometers, from about 100 micrometers to about 1000 micrometers, from about 500 micrometers to about 5000 micrometers, from about 1000 micrometers to about 10,000 micrometers, from about 1000 micrometers to about 5000 micrometers, or from about 2000 micrometers to about 8000 micrometers. In one or more illustrative examples, the mirrors 212, 214, 216, 218 can have a circular shape, a rectangular shape or a square shape. In various examples, the mirror array 210 can have hundreds of mirrors, thousands of mirrors, tens of thousands of mirrors, up to a million mirrors or more.

In various examples, the mirrors 212, 214, 216, 218 can have individual characteristics. For example, individual mirrors 212, 214, 216, 218 can each have at least one of a pitch, a tilt, or an angle of rotation. In one or more examples, the mirrors 212, 214, 216, 218 can be individually configurable such that at least a portion of the individual mirrors 212, 214, 216, 218 can have different characteristics. To illustrate, the mirrors of the mirror array 210 can be coupled to servo motors that can individually configure the characteristics of the mirrors. In one or more illustrative examples, mirrors of the mirror array 210 can reflect electromagnetic radiation or be considered to be “On” when a tilt of the mirrors are within a specified range of angles and the mirrors can be non-reflective or considered to be “Off” when a tilt of the mirrors are less than a threshold angle. In one or more illustrative examples, a tilt of a mirror in the “On” configuration can be at least 15°, at least 20°, at least 25°, at least 30°, at least 35°, or at least 40°.

In one or more additional examples, the microscope optical components 204 can include an optical component controller 220. The optical component controller 220 can provide at least one of signals or instructions to the emitter device 206 and the mirror array 210 to control characteristics of electromagnetic radiation emitted by the emitter device 206. In various examples, the optical component controller 220 can cause the electromagnetic radiation 208 to be emitted by the emitter device 206. In one or more illustrative examples, the optical component controller 220 can be configured to cause the emitter device 206 to emit the electromagnetic radiation 208 such that the electromagnetic radiation 208 has one or more specified wavelengths. In at least some examples, the one or more specified wavelengths can correspond to one or more wavelengths included in an experimental protocol. In various examples, the optical component controller 220 can cause one or more filters of the emitter device 206 to be applied in order to produce the electromagnetic radiation 208 having the one or more specified wavelengths. The optical component controller 220 can also control the emitter device 206 to emit the electromagnetic radiation 208 for one or more periods of time in accordance with an experimental protocol. Further, the optical component controller 220 can control the emitter device 206 to emit the electromagnetic radiation 208 such that the electromagnetic radiation 208 has an intensity specified by an experimental protocol.

The optical component controller 220 can also control the characteristics of the mirrors 212, 214, 216, 218 of the mirror array 210. For example, the optical component controller 220 can control at least one of the pitch, tilt, or rotation angle of each mirror of the mirror array 210. In one or more examples, the optical component controller 220 can configure the characteristics of the mirrors 212, 214, 216, 218 of the mirror array 210 according to an experimental protocol. To illustrate, the optical component controller 220 can configure the mirrors 212, 214, 216, 218 of the mirror array 210 to cause the electromagnetic radiation 208 to have a modified trajectory, such as at 222, in order to be incident upon a location of a sample container 224 coupled to a stage of the microscope 102.

In one or more illustrative examples, the sample container 224 can have a number of wells, such as wells 226, 228, 230, 232, and 234. Additionally, one or more biological cells can be located in the wells 226, 228, 230, 232, 234. For example, the well 226 can include a number of cells 236. In one or more additional illustrative examples, the optical component controller 220 can determine that an experimental protocol is to be implemented with respect to a cell 238 located in the well 226. In these scenarios, the optical component controller 220 can access a mapping that indicates configurations of the mirrors 212, 214, 216, 218 of the mirror array 210 that correspond to different locations of the sample container 224. Continuing with the example from above, the optical component controller 220 can determine a location of the biological cell 238 within the well 226 and use the mapping to determine a configuration of the mirrors 212, 214, 216, 218 of the mirror array 210 that correspond to the location of the biological cell 238. The optical component controller 220 can then cause the mirrors 212, 214, 216, 218 to be configured to the configuration that causes the electromagnetic radiation 208 to travel along the modified trajectory at 222 and be incident on the biological cell 238. To illustrate, the optical component controller 220 can send at least one of signals or instructions to one or more motors or other control device to cause at least one of the pitch, tilt, or rotation angle of at least one of the mirrors 212, 214, 216, 218 to be modified to conform to the configuration that corresponds to the mapping in relation to the location of the biological cell 238 within the sample container 224.

In various examples, one or more cameras of the microscope 102 can capture images of the biological cell 238 during one or more periods of time that the electromagnetic radiation 208 is incident on the biological cell 238. In one or more examples, the experimental protocol can indicate that at least one of different wavelengths of the electromagnetic radiation 208, different durations for applying the electromagnetic radiation 208, or different intensities of the electromagnetic radiation 208 are to be implemented with respect to the biological cell 238. in these instances, after a cycle of the experimental protocol is complete that corresponds to previous settings of the emitter device 206 and a previous configuration of the mirror array 210, the optical component controller 220 can cause the emitter device 206 to emit the electromagnetic radiation 208 having different characteristics that correspond to the next cycle of the experimental protocol. Additionally, in situations where the next cycle of the experimental protocol is to be applied to a different biological cell, the optical component controller 220 can cause a configuration of the mirror array to change to cause the electromagnetic radiation 208 to be incident on the location of the sample container 224 that corresponds to the different biological cell.

Although not shown in FIG. 2, the microscope 102 can also include or be coupled to a biological cell storage container. the biological cell storage container can provide an environment for the biological cells used with respect to the microscope 102 that preserves the viability of the biological cells. For example, the biological cell storage container can control an amount of carbon dioxide that the biological cells are exposed to. In one or more additional examples, the biological cell storage container can control a carbon dioxide to air ratio to maximize the viability of the cells.

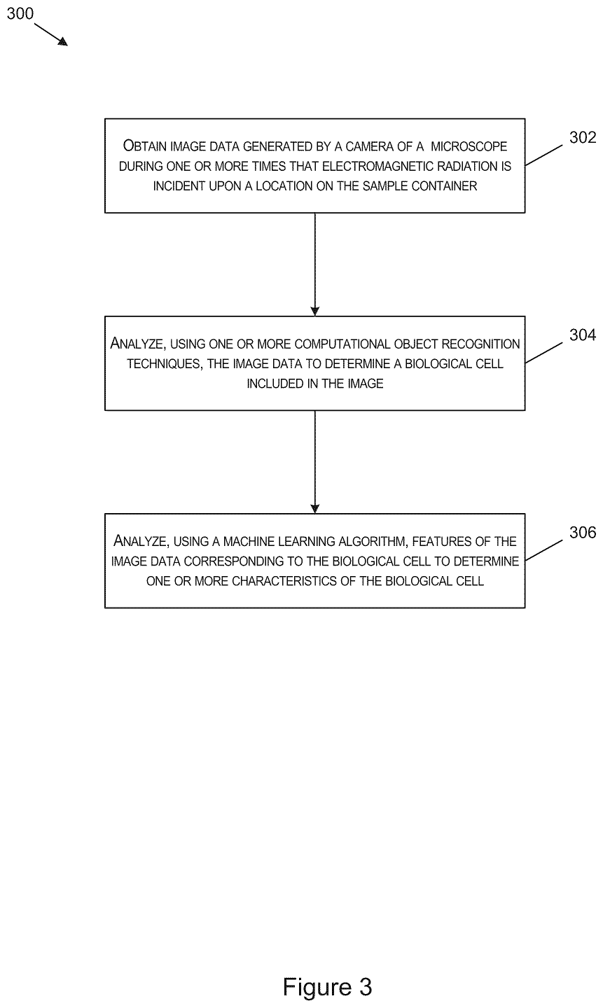

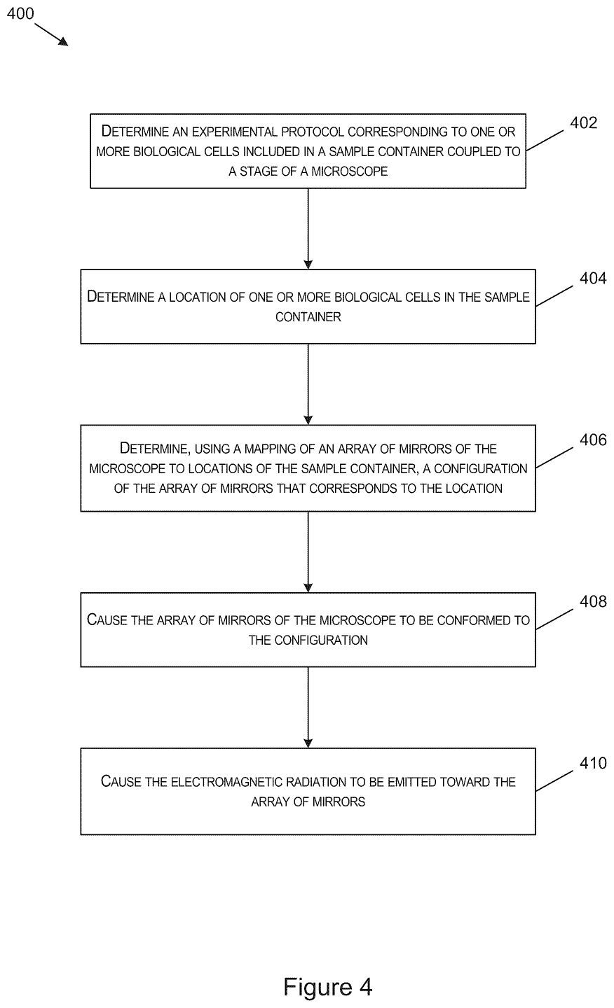

FIGS. 3 and 4 are a flow diagrams of a processes to analyze image data of biological cells upon which electromagnetic radiation has been applied and determine changes to experimental protocols based on the analysis of the images. At least a portion of the processes can be embodied in computer-readable instructions for execution by one or more processors such that the operations of the processes may be performed in part or in whole by the functional components of at least one of one or more user devices or one or more server systems. Accordingly, the processes described below are by way of example with reference thereto, in some situations. However, in other implementations, at least some of the operations of the processes described with respect to FIG. 3 and FIG. 4 may be deployed on various other hardware configurations. The processes described with respect to FIGS. 3 and 4 are therefore not intended to be limited to the being performed by one or more server systems or one or more user devices described herein and can be implemented in whole, or in part, by one or more additional components. Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

FIG. 3 is a flow diagram of a process 300 to analyze images obtained by a microscope and to control the operation of the microscope, according to one or more example implementations. At 302, the process 300 can include obtaining image data generated by a camera of a microscope. The image data can correspond to an image captured during electromagnetic radiation being incident upon a location on a sample container coupled to the microscope. The electromagnetic radiation can be applied to the biological cell as part of an experimental protocol. The experimental protocol can indicate one or more wavelengths to be incident upon one or more biological cells, a duration that the electromagnetic radiation is to be incident upon the one or more biological cells, and an intensity of the electromagnetic radiation incident upon the one or more biological cells. In one or more examples, data can be received indicating the location of the electromagnetic radiation and a configuration of an array of mirrors of the microscope can be determined that corresponds to the location. Electromagnetic radiation can be emitted toward the array of mirrors such that a trajectory of the electromagnetic radiation is modified to be incident on the location. In various examples, the one or more biological cells can include cells derived from a nervous system of subjects. For example, the one or more biological cells can be derived from tissue of one or more nervous system components of subjects. In one or more illustrative examples, the one or more biological cells can include neurons.

In addition, the process 300 can include, at 304, analyzing, using one or more computational object recognition techniques, the image data to determine a biological cell included in the image. In one or more examples, the biological cell can include one or more photosensitive moieties that undergo a detectable change in response to one or more wavelengths of electromagnetic radiation. In various examples, the one or more photosensitive moieties can include one or more proteins. In one or more illustrative examples, the one or more photosensitive moieties can include or be derived from channelrhodopsins and halorhodopsins. In one or more additional illustrative examples, the one or more photosensitive moieties can be synthesized by fusing light sensitive self-oligomerization domains to one or more proteins and/or peptides, such as kinase domains of receptor tyrosine kinases.

Further, at 306, the process 300 can include analyzing, using a machine learning algorithm, features of the image data corresponding to the biological cell to determine one or more characteristics of the biological cell. The one or more characteristics of the biological cell can include a state of the biological cell. In one or more examples, the state of the biological cell can indicate that the biological cell is free of a disease or that a disease is present in relation to a subject from which the biological cell was extracted. In one or more additional examples, the state of the biological cell indicates that a biological pathway can be active in relation to the biological cell or that the biological pathway can be inactive in relation to the biological cell.

In various examples, one or more modifications to the experimental protocol can be determined. The one or more modifications can include at least one of a modification to a wavelength of electromagnetic radiation applied to the one or more biological cells, a modification to a duration that the electromagnetic radiation is applied to the one or more biological cells, or a modification to an intensity of electromagnetic radiation applied to the one or more biological cells. In one or more examples, the one or more wavelengths of electromagnetic radiation can be applied to the one or more biological cells are modified by modifying one or more filters applied to the electromagnetic radiation emitted by an emitting device of the microscope. In at least some examples, the one or more modifications to the experimental protocol can be determined using a reinforcement machine learning algorithm, a transformer-based machine learning algorithm, a diffusion machine learning algorithm, or a machine vision machine learning algorithm. Further, the one or more modifications to the experimental protocol can be determined by analyzing the one or more characteristics of the biological cell in relation to one or more additional characteristics of biological cells that correspond to a target state of the one or more biological cells.

FIG. 4 is a flow diagram of a process 400 to direct electromagnetic radiation to a location of a microscope field, according to one or more example implementations. At 402, the process 400 can include determining an experimental protocol corresponding to one or more biological cells included in a sample container coupled to a stage of a microscope.

The process 400 can also include, at 404, determining a location of one or more biological cells in the sample container. The location to apply the electromagnetic radiation can be determined based on user input indicating that the experimental protocol is to be applied to the one or more biological cells. In various examples, the location to apply the electromagnetic radiation can be determined by retrieving information from a data store indicating a well of a well plate in which the one or more biological cells are located and an orientation of the well plate on a stage of the microscope.

Additionally, at 406, the process 400 can include determining, using a mapping of an array of mirrors of the microscope to locations of the sample container, a configuration of the array of mirrors that corresponds to the location. The configuration of the array of mirrors can indicate at least one of a pitch, a tilt, or an angle of rotation of individual mirrors of the array of mirrors. Further, the process 400 can include, at 408, causing the array of mirrors of the microscope to be conformed to the configuration.

At 410, the process 400 can include causing electromagnetic radiation to be emitted toward the array of mirrors. In one or more examples, the experimental protocol can be used to determine one or more wavelengths of electromagnetic radiation to be incident upon the location. An arrangement of one or more filters of the microscope can then be determined to cause the one or more wavelengths of electromagnetic radiation to be emitted. In addition, based on the experimental protocol, a duration can be determined to apply the electromagnetic radiation to the location. An intensity of the electromagnetic radiation can also be determined based on the experimental protocol.

In one or more examples, one or more images of the one or more biological cells can be captured during one or more times that the electromagnetic radiation is incident on the location of the sample container. experimental protocol is implemented by the microscope. The one or more images can be analyzed using one or more computational object recognition techniques to determine a biological cell of the one or more biological cells included in the image. In addition, a machine learning algorithm can be implemented to analyze features of the one or more images to determine one or more characteristics of the biological cell. In various examples, the one or more characteristics of the biological cell include a state of the biological cell and the state of the biological cell can indicate that (i) the biological cell is free of a disease or that a disease is present in relation to the biological cell or (ii) a biological pathway is active in relation to the biological cell or that the biological pathway is inactive in relation to the biological cell.

In at least some examples, the one or more characteristics of the biological cell can be used to determine one or more modifications to the experimental protocol. The one or more modifications to the experimental protocol can include at least one of a modification to a wavelength of electromagnetic radiation applied to the one or more biological cells, a modification to a duration that the electromagnetic radiation is applied to the one or more biological cells, or a modification to an intensity of electromagnetic radiation applied to the one or more biological cells. Further, the experimental protocol can indicate that the electromagnetic radiation is to be applied to a single cell in a well of the sample container. In at least some examples, multiple biological cells are located in the well, the biological cell is a first biological cell, and the experimental protocol is a first experimental protocol specifying one or more first wavelengths of electromagnetic radiation to apply to the first biological cell, a first duration to apply the one or more first wavelengths of electromagnetic radiation, and a first intensity of the electromagnetic radiation. In one or more illustrative examples, a second experimental protocol can be implemented with respect to the second biological cell in the well. The second experimental protocol can specify one or more second wavelengths of electromagnetic radiation to apply to the second biological cell, a second duration to apply the one or more second wavelengths of electromagnetic radiation, and a second intensity of the electromagnetic radiation. At least one of the one or more second wavelengths of electromagnetic radiation can be different from the one or more first wavelengths of electromagnetic radiation, the second duration can be different from the first duration, or the second intensity can be different from the first intensity.

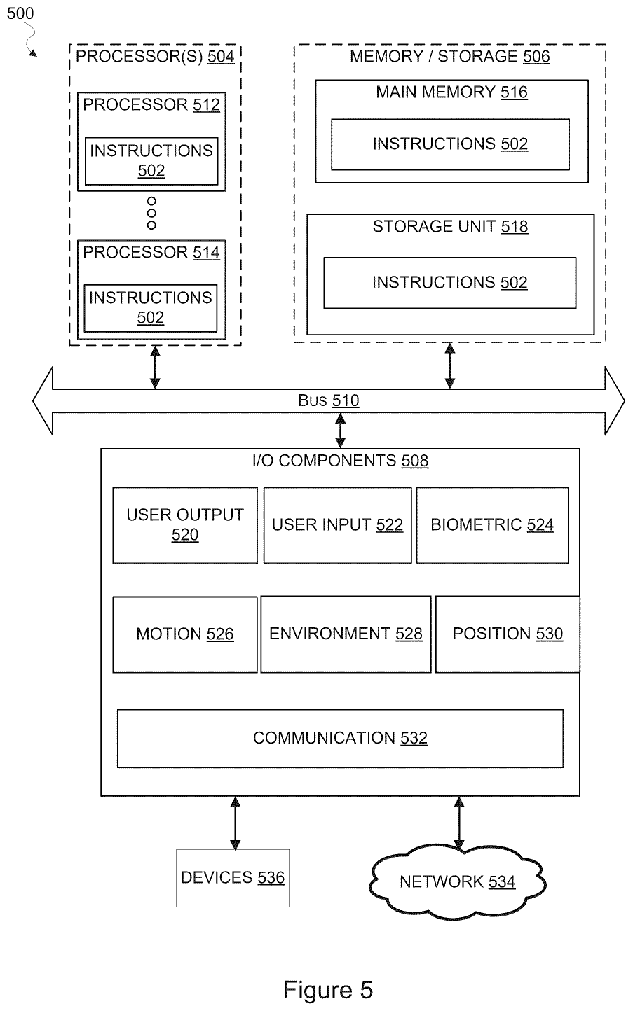

FIG. 5 is a block diagram illustrating components of a machine 500, according to some example implementations, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 502 (e.g., software, a program, an application, an applet, an app, or other executable code) for causing the machine 500 to perform any one or more of the methodologies discussed herein may be executed. As such, the instructions 502 may be used to implement modules or components described herein. The instructions 502 transform the general, non-programmed machine 500 into a particular machine 500 programmed to carry out the described and illustrated functions in the manner described. In alternative implementations, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a biological cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 502, sequentially or otherwise, that specify actions to be taken by machine 500. Further, while only a single machine 500 is illustrated, the term “machine” shall also be taken to include a collection of machines that individually or jointly execute the instructions 502 to perform any one or more of the methodologies discussed herein.

The machine 500 may include processors 504, memory/storage 506, and I/O components 508, which may be configured to communicate with each other such as via a bus 510. In an example implementation, the processors 504 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 502. The term “processor” is intended to include multi-core processors 504 that may comprise two or more independent processors (sometimes referred to as “cores”) that may execute instructions 502 contemporaneously. Although FIG. 5 shows multiple processors 504, the machine 500 may include a single processor 512 with a single core, a single processor 512 with multiple cores (e.g., a multi-core processor), multiple processors 512, 514 with a single core, multiple processors 512, 514 with multiple cores, or any combination thereof.

The memory/storage 506 may include memory, such as a main memory 516, or other memory storage, and a storage unit 518, both accessible to the processors 504 such as via the bus 510. The storage unit 518 and main memory 516 store the instructions 502 embodying any one or more of the methodologies or functions described herein. The instructions 502 may also reside, completely or partially, within the main memory 516, within the storage unit 518, within at least one of the processors 504 (e.g., within the processor's cache memory), or any suitable combination thereof, during execution thereof by the machine 500. Accordingly, the main memory 516, the storage unit 518, and the memory of processors 504 are examples of machine-readable media.

The I/O components 508 may include a wide variety of components to receive input, provide output, produce output, transmit information, exchange information, capture measurements, and so on. The specific I/O components 508 that are included in a particular machine 500 will depend on the type of machine. For example, portable machines such as mobile phones will likely include a touch input device or other such input mechanisms, while a headless server machine will likely not include such a touch input device. It will be appreciated that the I/O components 508 may include many other components that are not shown in FIG. 5. The I/O components 508 are grouped according to functionality merely for simplifying the following discussion and the grouping is in no way limiting. In various example implementations, the I/O components 508 may include user output components 520 and user input components 522. The user output components 520 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 522 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example implementations, the I/O components 508 may include biometric components 524, motion components 526, environmental components 528, or position components 530 among a wide array of other components. For example, the biometric components 524 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 526 may include acceleration sensor components (e.g., accelerometer), gravitation sensor components, rotation sensor components (e.g., gyroscope), and so forth. The environmental components 528 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 530 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 508 may include communication components 532 operable to couple the machine 500 to a network 534 or devices 536. For example, the communication components 532 may include a network interface component or other suitable device to interface with the network 534. In further examples, communication components 532 may include wired communication components, wireless communication components, biological cellular communication components, near field communication (NFC) components, Bluetooth® components (e.g., Bluetooth® Low Energy), Wi-Fi® components, and other communication components to provide communication via other modalities. The devices 536 may be another machine 500 or any of a wide variety of peripheral devices (e.g., a peripheral device coupled via a USB).

Moreover, the communication components 532 may detect identifiers or include components operable to detect identifiers. For example, the communication components 532 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 532, such as location via Internet Protocol (IP) geo-location, location via Wi-Fi® signal triangulation, location via detecting an NFC beacon signal that may indicate a particular location, and so forth.

As used herein, “component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an ASIC. A hardware component may also include programmable logic or circuitry that is temporarily configured by software to perform certain operations. For example, a hardware component may include software executed by a general-purpose processor 504 or other programmable processor. Once configured by such software, hardware components become specific machines (or specific components of a machine 500) uniquely tailored to perform the configured functions and are no longer general-purpose processors 504. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering implementations in which hardware components are temporarily configured (e.g., programmed), each of the hardware components need not be configured or instantiated at any one instance in time. For example, where a hardware component comprises a general-purpose processor 504 configured by software to become a special-purpose processor, the general-purpose processor 504 may be configured as respectively different special-purpose processors (e.g., comprising different hardware components) at different times. Software accordingly configures a particular processor 512, 514 or processors 504, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In implementations in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices, and can operate on a resource (e.g., a collection of information). The various operations of example methods described herein may be performed, at least partially, by one or more processors 504 that are temporarily configured (e.g., by software) or permanently configured to perform the relevant operations. Whether temporarily or permanently configured, such processors 504 may constitute processor-implemented components that operate to perform one or more operations or functions described herein. As used herein, “processor-implemented component” refers to a hardware component implemented using one or more processors 504. Similarly, the methods described herein may be at least partially processor-implemented, with a particular processor 512, 514 or processors 504 being an example of hardware. For example, at least some of the operations of a method may be performed by one or more processors 504 or processor-implemented components. Moreover, the one or more processors 504 may also operate to support performance of the relevant operations in a “cloud computing” environment or as a “software as a service” (SaaS). For example, at least some of the operations may be performed by a group of computers (as examples of machines 500 including processors 504), with these operations being accessible via a network 534 (e.g., the Internet) and via one or more appropriate interfaces (e.g., an API). The performance of certain of the operations may be distributed among the processors, not only residing within a single machine 500, but deployed across a number of machines. In some example implementations, the processors 504 or processor-implemented components may be located in a single geographic location (e.g., within a home environment, an office environment, or a server farm). In other example implementations, the processors 504 or processor-implemented components may be distributed across a number of geographic locations.

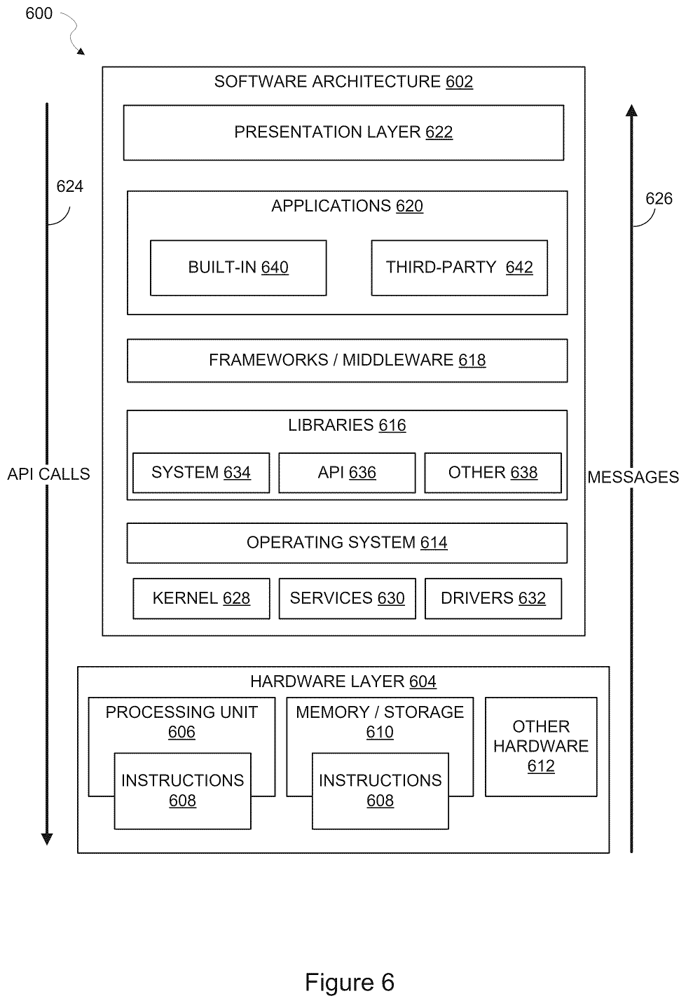

FIG. 6 is a block diagram illustrating system 600 that includes an example software architecture 602, which may be used in conjunction with various hardware architectures herein described. FIG. 6 is a non-limiting example of a software architecture, and it will be appreciated that many other architectures may be implemented to facilitate the functionality described herein. The software architecture 602 may execute on hardware such as machine 500 of FIG. 5 that includes, among other things, processors 504, memory/storage 506, and input/output (I/O) components 508. A representative hardware layer 604 is illustrated and can represent, for example, the machine 500 of FIG. 5. The representative hardware layer 604 includes a processing unit 606 having associated executable instructions 608. Executable instructions 608 represent the executable instructions of the software architecture 602, including implementation of the methods, components, and so forth described herein. The hardware layer 604 also includes at least one of memory or storage modules memory/storage 610, which also have executable instructions 608. The hardware layer 604 may also comprise other hardware 612.

In the example architecture of FIG. 6, the software architecture 602 may be conceptualized as a stack of layers where each layer provides particular functionality. For example, the software architecture 602 may include layers such as an operating system 614, libraries 616, frameworks/middleware 618, applications 620, and a presentation layer 622. Operationally, the applications 620 or other components within the layers may invoke API calls 624 through the software stack and receive messages 626 in response to the API calls 624. The layers illustrated are representative in nature and not all software architectures have all layers. For example, some mobile or special purpose operating systems may not provide a frameworks/middleware 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 are responsible for controlling or interfacing with the underlying hardware. For instance, the drivers 632 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 provide a common infrastructure that is used by at least one of the applications 620, other components, or layers. The libraries 616 provide functionality that allows other software components to perform tasks in an easier fashion than to interface directly with the underlying operating system 614 functionality (e.g., kernel 628, services 630, drivers 632). The libraries 616 may include system libraries 634 (e.g., C standard library) that may provide functions such as memory allocation functions, string manipulation functions, mathematical functions, and the like. In addition, the libraries 616 may include API libraries 636 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks/middleware 618 (also sometimes referred to as middleware) provide a higher-level common infrastructure that may be used by the applications 620 or other software components/modules. For example, the frameworks/middleware 618 may provide various graphical user interface functions, high-level resource management, high-level location services, and so forth. The frameworks/middleware 618 may provide a broad spectrum of other APIs that may be utilized by the applications 620 or other software components/modules, some of which may be specific to a particular operating system 614 or platform.

The applications 620 include built-in applications 640 and third-party applications 642. Examples of representative built-in applications 640 may include, but are not limited to, a contacts application, a browser application, a book reader application, a location application, a media application, a messaging application, or a game application. Third-party applications 642 may include an application developed using the ANDROID™ or IOS™ software development kit (SDK) by an entity other than the vendor of the particular platform and may be mobile software running on a mobile operating system such as IOS™, ANDROID™, WINDOWS® Phone, or other mobile operating systems. The third-party applications 642 may invoke the API calls 624 provided by the mobile operating system (such as operating system 614) to facilitate functionality described herein.

The applications 620 may use built-in operating system functions (e.g., kernel 628, services 630, drivers 632), libraries 616, and frameworks/middleware 618 to create UIs to interact with users of the system. Alternatively, or additionally, in some systems, interactions with a user may occur through a presentation layer, such as presentation layer 622. In these systems, the application/component “logic” can be separated from the aspects of the application/component that interact with a user.

At least some of the processes described herein can be embodied in computer-readable instructions for execution by one or more processors such that the operations of the processes may be performed in part or in whole by the functional components of one or more computer systems. Accordingly, computer-implemented processes described herein are by way of example with reference thereto, in some situations. However, in other implementations, at least some of the operations of the computer-implemented processes described herein can be deployed on various other hardware configurations. The computer-implemented processes described herein are therefore not intended to be limited to the systems and configurations described with respect to FIGS. 1-4 and can be implemented in whole, or in part, by one or more additional system and/or components.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, implementation, or composition that is “substantially free of” or “generally free of” an element may still actually contain such element as long as there is generally no significant effect thereof.

In the foregoing description various implementations of the present disclosure have been presented for the purpose of illustration and description. They are not intended to be exhaustive or to limit the invention to the precise form disclosed. Obvious modifications or variations are possible in light of the above teachings. The various implementations were chosen and described to provide the best illustration of the principals of the disclosure and their practical application, and to enable one of ordinary skill in the art to utilize the various implementations with various modifications as are suited to the particular use contemplated. All such modifications and variations are within the scope of the present disclosure as determined by the appended claims when interpreted in accordance with the breadth they are fairly, legally, and equitably entitled.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: obtaining, by one or more computing devices including one or more hardware processors and memory, image data generated by a camera of a microscope, the image data corresponding to an image captured during electromagnetic radiation being incident upon a location on a sample container coupled to the microscope; analyzing, by at least one computing device of the one or more computing devices and using one or more computational object recognition techniques, the image data to determine a biological cell included in the image; analyzing, by at least one computing device of the one or more computing devices and using a machine learning algorithm, features of the image data corresponding to the biological cell to determine one or more characteristics of the biological cell.

In Example 2, the subject matter of Example 1 includes, wherein the one or more characteristics of the biological cell include a state of the biological cell.

In Example 3, the subject matter of Example 2 includes, wherein the state of the biological cell indicates that the biological cell is free of a disease or that a disease is present in relation to the biological cell.

In Example 4, the subject matter of Examples 2-3 includes, wherein the state of the biological cell indicates that a biological pathway is active in relation to the biological cell or that the biological pathway is inactive in relation to the biological cell.

In Example 5, the subject matter of Examples 1-4 includes, wherein the electromagnetic radiation is applied to the biological cell as part of an experimental protocol.

In Example 6, the subject matter of Example 5 includes, wherein the experimental protocol indicates one or more wavelengths to be incident upon one or more biological cells, a duration that the electromagnetic radiation is to be incident upon the one or more biological cells, and an intensity of the electromagnetic radiation incident upon the one or more biological cells.

In Example 7, the subject matter of Examples 5-6 includes, determining, by at least one computing device of the one or more computing devices, one or more modifications to the experimental protocol, wherein the one or more modifications include at least one of a modification to a wavelength of electromagnetic radiation applied to the one or more biological cells, a modification to a duration that the electromagnetic radiation is applied to the one or more biological cells, or a modification to an intensity of electromagnetic radiation applied to the one or more biological cells.

In Example 8, the subject matter of Example 7 includes, wherein the one or more wavelengths of electromagnetic radiation applied to the one or more biological cells are modified by modifying one or more filters applied to the electromagnetic radiation emitted by an emitting device of the microscope.

In Example 9, the subject matter of Examples 7-8 includes, wherein the one or more modifications to the experimental protocol are determined using a reinforcement machine learning algorithm, a diffusion machine learning algorithm, a machine vision machine learning algorithm, or a large language model machine learning algorithm.

In Example 10, the subject matter of Examples 7-9 includes, wherein the one or more modifications to the experimental protocol are determined by analyzing, by at least one computing device of the one or more computing devices, the one or more characteristics of the biological cell in relation to one or more additional characteristics of biological cells that correspond to a target state of the one or more biological cells.

In Example 11, the subject matter of Examples 1-10 includes, wherein the one or more biological cells include one or more photosensitive moieties that undergo a detectable change in response to one or more wavelengths of electromagnetic radiation.

In Example 12, the subject matter of Examples 1-11 includes, receiving data indicating the location of the electromagnetic radiation; determining a configuration of an array of mirrors of the microscope that correspond to the location; and causing electromagnetic radiation to be emitted to the array of mirrors such that a trajectory of the electromagnetic radiation is modified to be incident on the location.

Example 13 is a method comprising: determining an experimental protocol corresponding to one or more biological cells included in a sample container coupled to a stage of a microscope; determining a location of one or more biological cells in the sample container; determining, using a mapping of an array of mirrors of the microscope to locations of a field of view of a camera of the microscope, a configuration of the array of mirrors that corresponds to the location; causing the array of mirrors of the microscope to be conformed to the configuration; and causing electromagnetic radiation to be emitted toward the array of mirrors.

In Example 14, the subject matter of Example 13 includes, wherein the configuration of the array of mirrors indicates at least one of a pitch, a tilt, or an angle of rotation of individual mirrors of the array of mirrors.

In Example 15, the subject matter of Examples 13-14 includes, determining, based on the experimental protocol, one or more wavelengths of electromagnetic radiation to be incident upon the location; and determining an arrangement of one or more filters of the microscope to cause the one or more wavelengths of electromagnetic radiation to be emitted.

In Example 16, the subject matter of Examples 13-15 includes, determining, based on the experimental protocol, a duration to apply the electromagnetic radiation to the location; and determining, based on the experimental protocol, an intensity of the electromagnetic radiation.

In Example 17, the subject matter of Examples 13-16 includes, determining the location to apply the electromagnetic radiation based on user input indicating that the experimental protocol is to be applied to the one or more biological cells.

In Example 18, the subject matter of Examples 13-16 includes, determining the location to apply the electromagnetic radiation by retrieving information from a data store indicating a well of a well plate in which the one or more biological cells are located and an orientation of the well plate on a stage of the microscope.

In Example 19, the subject matter of Examples 13-18 includes, capturing one or more images of the one or more biological cells during one or more times that the electromagnetic radiation is incident on the location of the sample container. experimental protocol is implemented by the microscope.

In Example 20, the subject matter of Example 19 includes, analyzing, using one or more computational object recognition techniques, the one or more images to determine a biological cell of the one or more biological cells included in the image; analyzing, using a machine learning algorithm, features of the one or more images to determine one or more characteristics of the biological cell.

In Example 21, the subject matter of Example 20 includes, wherein: the one or more characteristics of the biological cell include a state of the biological cell; and the state of the biological cell indicates that (i) the biological cell is free of a disease or that a disease is present in relation to the biological cell or (ii) a biological pathway is active in relation to the biological cell or that the biological pathway is inactive in relation to the biological cell.

In Example 22, the subject matter of Example 20 includes, determining, based on the one or more characteristics of the biological cell, one or more modifications to the experimental protocol, wherein the one or more modifications include at least one of a modification to a wavelength of electromagnetic radiation applied to the one or more biological cells, a modification to a duration that the electromagnetic radiation is applied to the one or more biological cells, or a modification to an intensity of electromagnetic radiation applied to the one or more biological cells.

In Example 23, the subject matter of Examples 13-22 includes, wherein the experimental protocol indicates that the electromagnetic radiation is to be applied to a single cell in a well of the sample container.

In Example 24, the subject matter of Example 23 includes, wherein: multiple biological cells are located in the well; the biological cell is a first biological cell; and the experimental protocol is a first experimental protocol specifying one or more first wavelengths of electromagnetic radiation to apply to the first biological cell, a first duration to apply the one or more first wavelengths of electromagnetic radiation, and a first intensity of the electromagnetic radiation.

In Example 25, the subject matter of Example 24 includes, implementing a second experimental protocol with respect to the second biological cell in the well; wherein the second experimental protocol specifies one or more second wavelengths of electromagnetic radiation to apply to the second biological cell, a second duration to apply the one or more second wavelengths of electromagnetic radiation, and a second intensity of the electromagnetic radiation.

In Example 26, the subject matter of Example 25 includes, wherein at least one of the one or more second wavelengths of electromagnetic radiation are different from the one or more first wavelengths of electromagnetic radiation, the second duration is different from the first duration, or the second intensity is different from the first intensity.

Example 27 is an apparatus comprising: a microscope including: a stage, one or more cameras; an array of mirrors; and an emitter device that emits electromagnetic radiation; and a microscope controller configured to: determine one or more wavelengths of electromagnetic radiation to apply to a location on a sample container coupled to the stage; cause individual mirrors of the array of mirrors to have a configuration that causes a trajectory of the electromagnetic radiation emitted by the emitter device to be modified to an additional trajectory that corresponds to the location on the sample container.

In Example 28, the subject matter of Example 27 includes, wherein the individual mirrors of the array of mirrors have dimensions from about 100 micrometers to about 1000 micrometers.

In Example 29, the subject matter of Examples 27-28 includes, wherein the microscope controller is configured to capture one or more images of a biological cell that corresponds to the location of the sample container at one or more times that the electromagnetic radiation is incident upon the biological cell.

In Example 30, the subject matter of Examples 27-29 includes, wherein the apparatus can perform the methods of any one of Examples 1-26.

Example 31 is at least one machine-readable medium including instructions that, when executed by processing circuitry, cause the processing circuitry to perform operations to implement of any of Examples 1-30.

### EXAMPLES

The techniques described herein can include microscopes that are equipped to enable the system to register the position of a plate in the plate holder, and to return to any specific microscope field on the plate at any future time point, even after the plate has been removed and then returned to the stage. This capability enables the identification and longitudinal tracking of individual cells and the performance of repeated measurements. To maximize throughput, the implementations of the microscope described herein is also equipped with a hybrid computing environment that separates real time control of the optics hardware and the distributed analysis of acquired images for deep learning models. This configuration optimizes computational resources, leveraging GPU acceleration to allow for efficient deep learning tasks while maintaining control of microscope functions and seamless integration with hardware and software.

Inventive features of the microscopes described herein can include the added hardware and software that allow the system to analyze images of individual cells on the fly, devise an experimental perturbation tailored to each cell in a well and perform it on each cell independently of the experiment it devises and performs on a neighboring cell. The implementations of the microscope described herein thus eliminates the need for manual experimentation, reduces human bias and increases reproducibility. The system then allows sufficient time to elapse for each cell to produce and record a response (or a cascade of responses) to its perturbation, which can unfold over milliseconds to months depending on the biology. The system then uses the record of the response from each cell and the results of its real-time analysis of that response to devise another experiment, which is tailored to each cell and its response, and repeat the process in an autonomous way, for as long as the cell allows or the investigator wishes. The system may devise initial perturbations to explore in a systematic way a wide “biological space” to uncover a coarse-grained landscape of the biological stimulus-response relationships. Then the system can devise experiments to explore interesting regions of the landscape with more “fine-grained” perturbations. Or, if the system is tasked with driving the biology toward a particular goal, it can focus on perturbations that incrementally move the biological system toward that goal to try to uncover improved perturbations that bring it closest to the goal. In sum, the invention “closes the loop” because it allows the microscope to not only record and analyze images, but also to analyze the results of its own experiment and then design and perform subsequent experiments ad infinitum, in the process building knowledge autonomously.

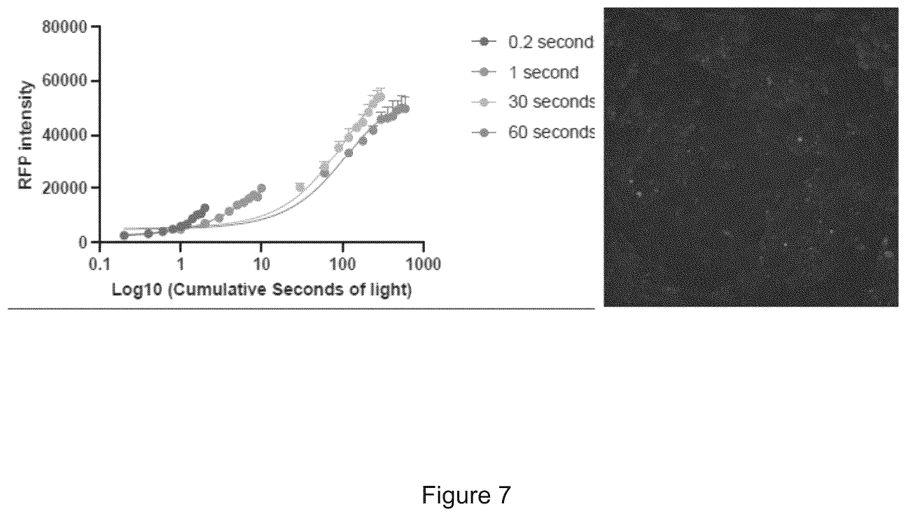

To enable these capabilities, the invention required several conceptual and engineering innovations. To perform experiments autonomously, the implementations of the microscope described herein was equipped with a digital micromirror device (DMD) that allows us to direct beams of light to precise locations in the microscope field. A DMD is a matrix of opto-mechanical micromirrors that can be independently controlled via software to achieve precise spatiotemporal illumination of the sample. The mirrors are also reflective over a broad range of wavelengths to accommodate the spectral-sensitivity of the various fluorescent biosensors we use to track biology or induce perturbations in our cells. The DMD can be programmed to produce spatially resolved beams as big as an entire microscope field (˜ 1 mm) or be limited to an area of a few microns, less than the size of single cell (FIG. 7). This feature allows the system to perturb either all the cells in the field of view simultaneously or just a fraction of them or even just an individual cell and not its neighbors. In addition, the DMD enables us to control the intensity, duration and frequency of illumination precisely and quantitatively. Once delivered to cells, light is converted to a desired biological perturbation by specific optogenetic biosensors introduced into cells (FIG. 1). To date, we have relied on existing optogenetic tools to develop the system, but optogenetic technology is modular and versatile and new biosensors can be developed to explore all manner of biological processes (see “Optical Control of Biology” below).

The innovations describe herein include precisely mapping locations within the microscope field to the mirrors of the DMD. This was essential to enable the DMD to send light to specific addresses within a microscope field-a specific cell or group of cells in the field, or a specific location within a specific cell. We met this challenge by developing precise transformation affines between microscope field and DMD. After calibration of the DMD, multiple functions were written to perturb the cells in a variety of ways. For instance, a “custom exposure” function was added to stimulate cells differently depending on their location within the well; a power function was added to modulate the intensity of light that is applied to the cells. Finally, a zero function was also added to track cells that do not receive any optical perturbations, a crucial control that is included within each iteration of the experiment. These DMD functions provide the system's AI with a range of knobs and levers to modulate experimental perturbations.

The software innovations broadly fall into two categories. One category consists of specific programs written to control the illumination, DMD, optical filter selection, stage movements, focus, and camera functions so as to achieve specific stimulus paradigms and data collections. The main innovations here involve design features aimed at speeding the I/O because the demands of closed loop analysis/experimentation/learning are high. To this end, we developed and incorporated a reference database and novel workflow. The reference PostgreSQLdatabase was developed in house to store experimental conditions as well as provide metadata while training foundation models. This custom database is used to store multiple parameters pertaining to the experiment such as the wavelength of light used for stimulation, filter features, cell morphometric values, label IDs for various cells and their tracks over multiple time points. The transforms for mapping the DMD to the camera are also stored in the database.

The second category of software innovation concerns image analysis and devising experimental perturbations. For image analysis, we have previously developed standard analysis pipelines with modules that perform image segmentation, cell identification, cell tracking and morphological analysis. We incorporated these into the pipeline implemented with respect to implementations of the microscope described herein when appropriate. In other cases, we have developed supervised and semi-supervised machine learning/deep learning methods to analyze images resulting in the identification of features that can be used as the basis for devising tailored experiments. A variety of software tools are used to devise experiments and to develop knowledge from the results of the experiments, such as those used to develop foundation models, including transformers and reinforcement learning. For example, a local instance of Cellpose, which is a U-Net deep learning model to perform segmentation, is included in the repertoire of algorithms to obtain masks of the cells.

### Optical Control of Biology

Implementations of the microscope described herein were designed to use light to perturb cells because light offers many advantages for generating the rich datasets needed for training foundation models of biological systems that contain the broadest possible range of stimulus-response relationships. Light provides nearly unlimited options to vary the intensity, duration, temporal pattern and spatial extent of a stimulation, it can be delivered rapidly and inexpensively, and it can be placed under autonomous closed loop computer control. This section describes the transducers that convert stimulation with light to a biological stimulus, which are required in the recipient cells.

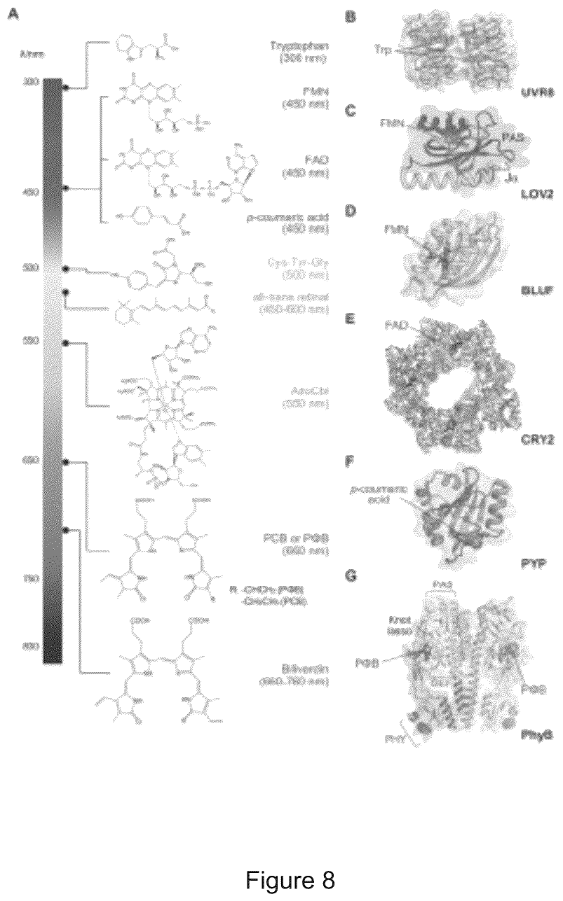

Diverse biological systems have evolved light-sensitive proteins and co-factors to mediate critical biological functions such as phototaxis or circadian entrainment. The photosensing chromophores or co-factors vary in structure and spectral sensitivity (FIG. 8). In general, upon absorption of a photon, photoreceptors undergo a conformational change in the photosensitive domains that can be propagated to effector domains of the proteins that contain them.

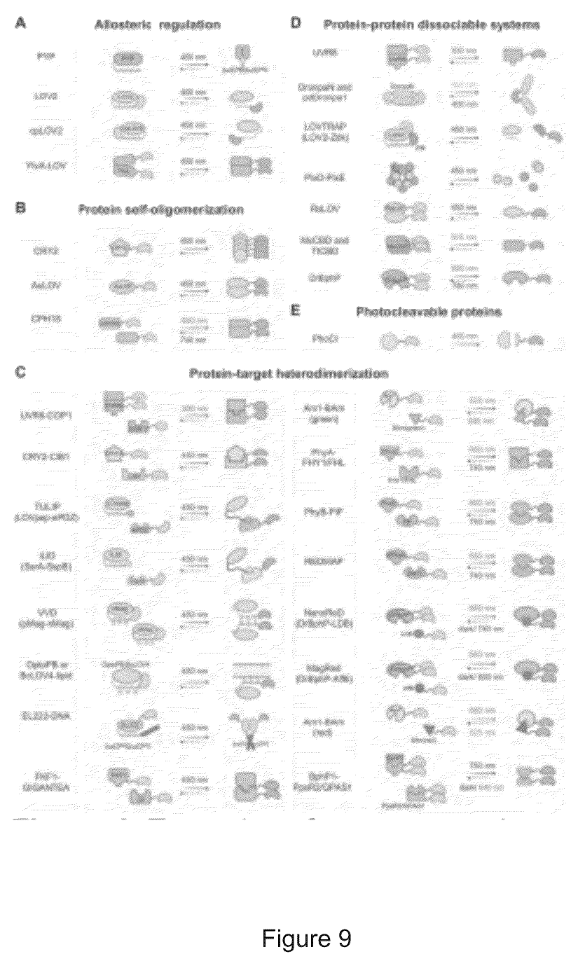

In some cases, light-sensitive proteins have been used in toto to stimulate biological systems in desired ways. For example, channelrhodopsins and halorhodopsins are light-gated ion channels discovered in algae that have been adapted and expressed in the mammalian nervous system to activate or inhibit genetically defined neural circuits with light. The modular nature of other light-sensitive proteins has made it possible to isolate the light-sensitive domains and fuse them to effector domains of other peptides to develop new synthetic biological tools to control diverse biology with light (FIG. 9). The fact that different transducers respond to different wavelengths of light is also important because it means that diverse transducers can be designed and multiplexed in the same cell to enable the implementations of the microscope described herein to independently control different biological pathways with different wavelengths of light at once.

Hundreds of biochemical mechanisms have already been successfully placed under the control of light. Fusing light sensitive self-oligomerization domains to kinase domains of receptor tyrosine kinases (RTKs), confers light-induced activation. RTKs play critical roles in development, cancer and synaptic plasticity. GTPases and guanine nucleotide exchange factors (GEFs) serve as molecular switches for many fundamental biological processes that are the target of many FDA-approved drugs. Investigators have discovered at least three different ways to create light-sensitive strategies to control GTPase or GEF function. The activation of many enzymatic pathways depends on clustering key components in space and time. Using domains that undergo light-inducible oligomerization, investigators have developed tools to investigate phospholipid metabolism, other kinases, and the production of 2nd messengers cAMP and cGMP.

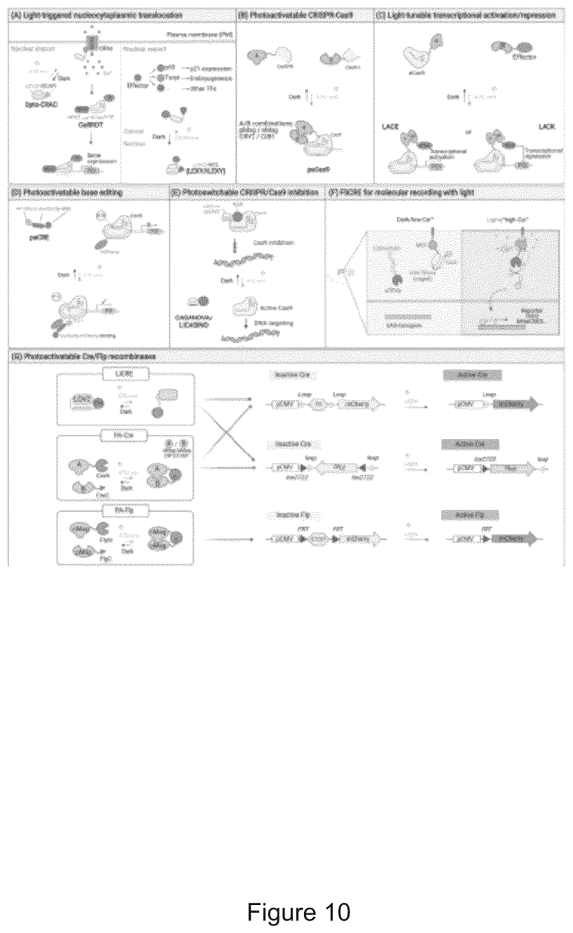

By fusing light-sensitive domains to key regulatory proteins, it has been possible to control more complex biology including cytoskeleton dynamics, cellular mechanics, organelle targeting/repositioning, interorganellar communication, membraneless organelle formation and phase separation. Among these, exciting new optogenetic tools have been created, in some cases by conferring light sensitivity to CRISPR/Cas9, to exert transcriptional control or do genetic engineering (FIG. 10).

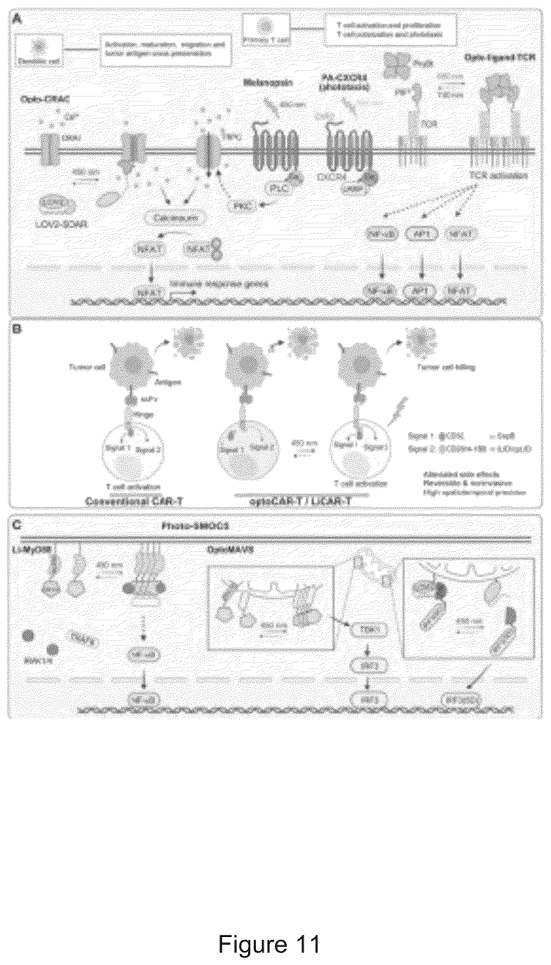

Finally, these optogenetic systems have been adapted to discover stimulation patterns to achieved desired complex biological responses. FIG. 11 shows optogenetic control of immunomodulation For example, immunomodulation is a dynamic process by which innate or adaptive immunity can be synthetically or genetically modulated for host defense and to reverse immunosuppression of cytotoxic T cells and traffic them towards tumors. Optogenetics have been adapted to boost antitumor immune response in dendritic cells or calm overactive effector T cells expressing and activating a light-inducible Ca2+ channel (Opto-CRAC), depending on the pattern of stimulation. An opto-ligand T-cell receptor (TCR) system has been developed that allows precise control of the duration of ligand-TCR binding and the degree of downstream TCR signaling activation. Optogenetics has also been used to control the activity of therapeutic immune cells, including chimeric antigen receptor (CAR) T cells. Light-sensitive or -switchable chimeric antigen receptors have been developed to conditionally reconstitute a split CAR into a fully functional CAR in the presence of blue light. By tuning the temporal frequency of light input in optoCAR-T cells, it is possible to mimic dynamic interactions patterns encountered by T cells in the human body.

### Applications of the Implementations of the Microscope Described Herein

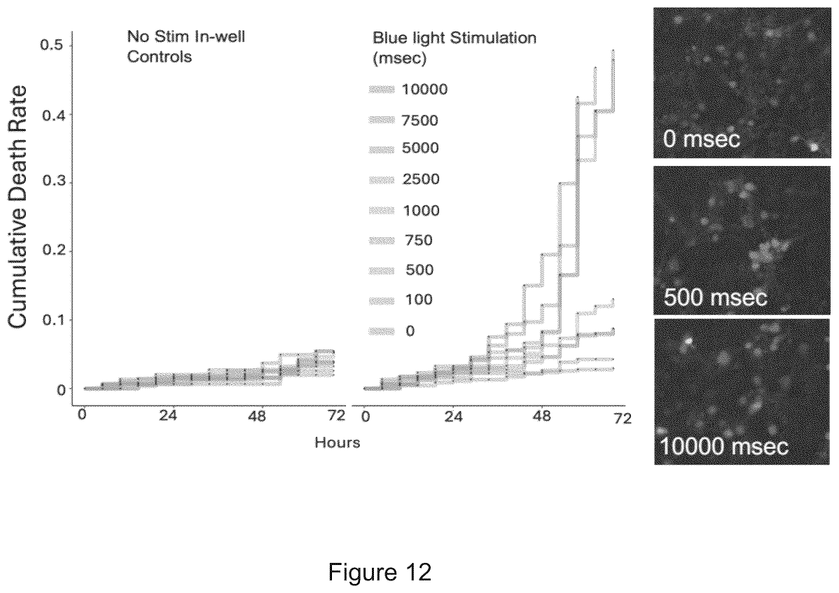

We have embarked on a series of experiments with the implementations of the microscope described herein and biological samples transduced with various optogenetic tools to demonstrate the ability to demonstrate the capabilities of the implementations of the microscope described herein to autonomously control biology with light and achieve overall POC. In the first, we introduced an optogenetic tool, miniSOG, that mediates light-induced oxygen free radical formation. Oxygen free radicals can be produced by dysfunction mitochondria and play roles in aging and disease by damaging DNA and proteins. In this first example, we demonstrate the ability to introduce miniSOG into neurons, deliver different doses of light and the follow each of the cells longitudinally to determine the relationship between the intensity of stimulation and the ultimate effect on neurodegeneration, measured here with a biosensor we developed called the Genetically Encoded Death Indicator (GEDI) and quantified with Kaplan-Meier and survival analysis and graphed as the cumulative risk of death (FIG. 12). Crucially, the cells left unstimulated as controls were in the same well as the cells stimulated with different doses of light. The fact that the cumulative death rate of the control cells remains low and underscores the power of the system to determine dose-response relationships at a single cell level.

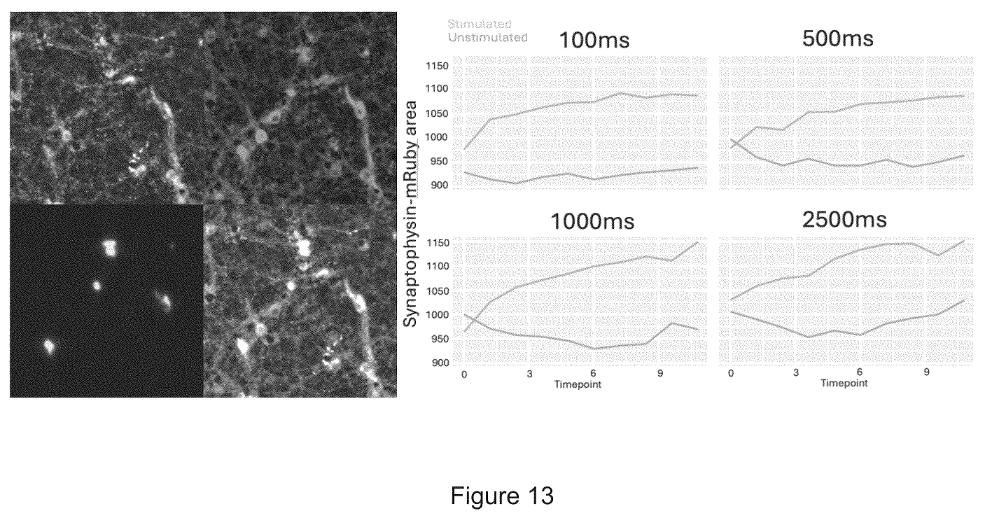

Next, we performed and experiment to demonstrate the capacity of the system to promote normal biology (FIG. 13). It is well established that specific patterns of neuronal electrical activity can trigger short and long-term biochemical pathways and new gene expression that can lead to the formation of new synapses and the growth of existing ones. This process, called neuroplasticity, is critical for learning and memory. In this experiment, we introduced channelrhodopsin (ChR2-EGFP), a light-activated ion channel into neurons to enable us to excite neurons with light. We co-transduced neurons with synaptophysin-mRuby, which is a presynaptic protein that labels synapses. We demonstrate that we can produce an increase in the fluorescent reporter of synapses (synaptophysin-mRuby) with neuronal excitation delivered by the implementations of the microscope described herein.

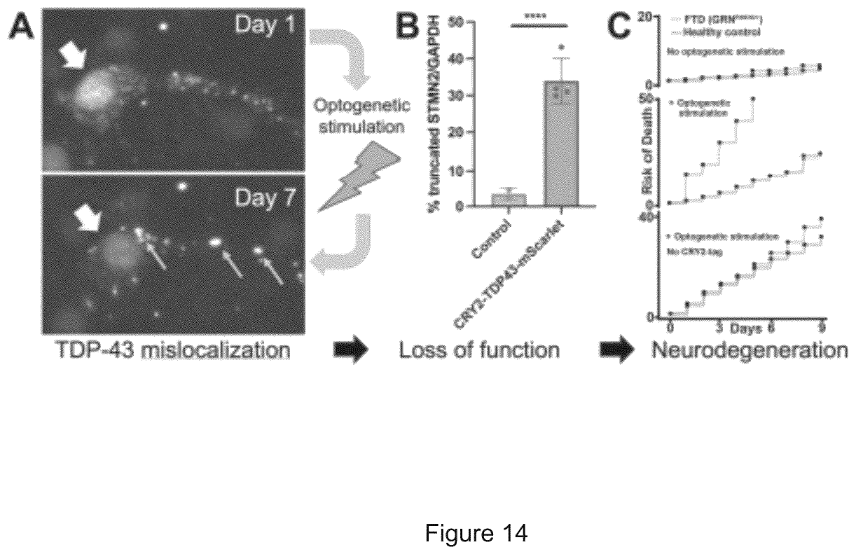

Next, we wondered if we could model disease with the implementations of the microscope described, triggering pathogenic cascades and recapitulating disease associated phenotypes (FIG. 14). We chose to focus on Tar DNA binding protein (TDP-43), because rare mutations in TDP-43 cause dominant forms of ALS and FTD, so TDP-43 pathology is likely to be a pathogenic driver of disease.

Critically, TDP-43 pathology is found in 98% of all patients with ALS, ˜50% with frontotemporal dementia (FTD) and is a poor prognostic marker in patients with Alzheimer's disease and so it is highly relevant to multiple neurodegenerative diseases. We adapted a previously reported system to induce TDP-43 oligomerization with light by appending a CRY2 sequence33. Neurons were transduced with the light-sensitive version of TDP-43 (CRY2-TDP-43-mScarlet). Upon stimulation with blue light, and in a dose-dependent way, nuclear depletion (yellow arrows) and cytoplasmic aggregation (orange arrows) of TDP-43 appeared over hours to days. Nuclear depletion of TDP-43 causes a loss of its nuclear gene splicing function and the aberrant retention of cryptic exons in genes. RT-PCR analysis these cultures revealed light-induced missplicing of TDP-43 clients, such as Stathmin. Eventually, significant neurodegeneration was observed in neurons in cells that depended on light stimulation (top vs middle panel) and the presence of the CRY2 tag (bottom vs middle panel) and was enhanced by an underlying genetic susceptibility to TDP-43 proteinopathy (middle panel: blue vs mauve line) (n=120-800 neurons per condition). In sum, with the implementations of the microscope described herein, we were able to recapitulate the cascade of TDP-43 mislocalization, loss of nuclear function, cytoplasmic aggregation and neurodegeneration seen in ALS and FTD. These results demonstrate the ability of the implementations of the microscope described herein to deliver a range of stimuli to different cells and generate datasets that contain diverse responses that range from those found normally in healthy neurons to those trigger pathogenic cascades seen in disease. Unexpectedly, we also were able to reveal a dose-dependent susceptibility to TDP-43 proteinopathy in a model of FTD caused by haploinsufficiency of progranulin (GRN) with the implementations of the microscope described herein. Understanding the factors that are important for cellular resiliency could provide insights into healthy aging and broad strategies to resist diseases of aging.

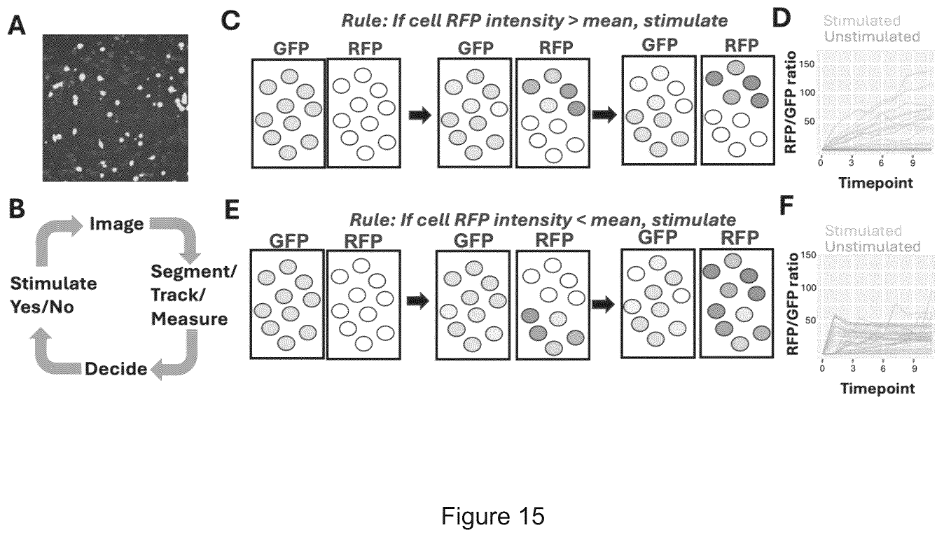

Finally, we aimed to demonstrate the capability of the system to perform a basic closed loop experiment in which the microscope observed an initial cell state, made a stimulus decision based on that state, and then observed the response to that stimulation (FIG. 15). First, we introduced the photo-switchable protein, Eos4b into neurons. Eos4b is a green fluorescent protein after it is synthesized. However, in response to a pulse of blue light, it can be photoconverted irreversibly to a red fluorescent protein. The amount of Eos4b produced by each cell will vary initially depending on the dose of the gene they received and the productivity of the cell. We took advantage of that variation, and asked the implementations of the microscope described herein initially to observe each cell and determine if its green fluorescence was in the upper or lower half of the distribution. Based on that determination, the implementations of the microscope described herein then made a stimulation decision that would cause photoconversion and an increase in red fluorescence. The results demonstrate that the microscope can complete a closed loop in which it initially observes each cell, makes a determination whether to stimulate based on that observation, delivers a stimulation accordingly and in a cell-specific way, and then observes the response to its stimulation.

What is claimed is:

1. An apparatus comprising:
a microscope including:
a stage,
one or more cameras;
an array of mirrors; and
an emitter device that emits electromagnetic radiation; and
a microscope controller that operates to:
determine one or more wavelengths of electromagnetic radiation to apply to a location on a sample container coupled to the stage; and
cause individual mirrors of the array of mirrors to have a configuration that causes a trajectory of the electromagnetic radiation emitted by the emitter device to be modified to an additional trajectory that corresponds to the location on the sample container.

2. The apparatus of claim 1, wherein the array of mirrors is located beneath the stage and at least a portion of the individual mirrors of the array of mirrors are controlled by servo motors.

3. The apparatus of claim 1, wherein the configuration of the array of mirrors indicates at least one of a pitch, a tilt, or an angle of rotation of individual mirrors of the array of mirrors.

4. The apparatus of claim 1, wherein the emitter device includes a number of filters with individual filters of the number of filters causing electromagnetic radiation of a specified wavelength range to be emitted.

5. The apparatus of claim 1, wherein the individual mirrors of the array of mirrors have dimensions from about 100 micrometers to about 1000 micrometers.

6. The apparatus of claim 1, wherein:
the microscope includes an image capture device; and
the microscope controller operates to capture one or more images of one or more wells of the sample container during one or more times that the electromagnetic radiation is incident on the location of the sample container.

7. The apparatus of claim 1, wherein the electromagnetic radiation is emitted according to an experimental protocol that indicates (i) one or more wavelengths of electromagnetic radiation to be incident upon the location and (ii) an arrangement of one or more filters of the microscope to cause the one or more wavelengths of electromagnetic radiation to be emitted.

8. The apparatus of claim 7, wherein the microscope controller operates to apply the electromagnetic radiation to the location for a duration specified by the experimental protocol and with an intensity specified by the experimental protocol.

9. A method comprising:
providing a microscope including a stage, one or more cameras, an array of mirrors; and an emitter device that emits electromagnetic radiation;
determining one or more wavelengths of electromagnetic radiation to apply to a location on a sample container coupled to the stage; and
causing individual mirrors of the array of mirrors to have a configuration that causes a trajectory of the electromagnetic radiation emitted by the emitter device to be modified to an additional trajectory that corresponds to the location on the sample container.

10. The method of claim 9, wherein:
the one or more wavelengths of electromagnetic radiation are applied to the location on the sample container according to an experimental protocol; and
the experimental protocol includes (i) a first set of protocol parameters indicating a first range of wavelengths to apply to a first location of the sample container for a first period of time and at one or more first intensities and (ii) a second set of protocol parameters indicating a second range of wavelengths to be applied to a second location of the sample container for a second period of time at one or more second intensities.

11. The method of claim 10, wherein the first location of the sample container includes a first sample and the second location of the sample container includes a second sample different from the first sample.

12. The method of claim 10, comprising:
causing the first set of protocol parameters to be applied to the first location of the sample container concurrently with applying the second set of protocol parameters to the second location of the sample container.

13. The method of claim 9, comprising:
receiving data indicating the location of the electromagnetic radiation;
determining a configuration of an array of mirrors of the microscope that correspond to the location; and
causing electromagnetic radiation to be emitted to the array of mirrors such that a trajectory of the electromagnetic radiation is modified to be incident on the location.

14. The method of claim 9, comprising:
performing a calibration process to determine a mapping of individual locations of the sample container to configurations of the individual mirrors of the array or mirrors, wherein the mapping indicates that the configurations of the individual mirrors of the array or mirrors correspond to locations of a field of view of a camera of the microscope.

15. The method of claim 9, comprising:
causing a tilt of one or more first mirrors of the array of mirrors to reflect the electromagnetic radiation onto one or more locations of the sample container; and
causing an additional tilt of one or more second mirrors of the array of mirrors to cause the one or more second mirrors to be non-reflective of the electromagnetic radiation.

16. A method comprising:
determining an experimental protocol corresponding to one or more samples included in a sample container coupled to a stage of a microscope;
determining a location of the one or more samples included in the sample container;
determining, using a mapping of an array of mirrors of the microscope to locations of a field of view of a camera of the microscope, a configuration of the array of mirrors that corresponds to the location;
causing the array of mirrors of the microscope to be conformed to the configuration; and
causing electromagnetic radiation to be emitted toward the array of mirrors.

17. The method of claim 16, wherein:
the configuration of the array of mirrors indicates at least one of a pitch, a tilt, or an angle of rotation of individual mirrors of the array of mirrors; and
the method comprises:
determining, based on the experimental protocol, one or more wavelengths of electromagnetic radiation to be incident upon the location; and
determining an arrangement of one or more filters of the microscope to cause the one or more wavelengths of electromagnetic radiation to be emitted.

18. The method of claim 16, comprising:
determining the location to apply the electromagnetic radiation by retrieving information from a data store indicating a well of a well plate in which the one or more samples are located and an orientation of the well plate on a stage of the microscope.

19. The method of claim 16, comprising:
capturing one or more images of the one or more samples during one or more times that the electromagnetic radiation is incident on the location of the sample container;
analyzing, using one or more computational object recognition techniques, the one or more images to determine a sample of the one or more samples included in the one or more images; and
analyzing features of the one or more images to determine one or more characteristics of the sample.

20. The method of claim 19, comprising:
determining, based on the one or more characteristics of the sample, one or more modifications to the experimental protocol, wherein the one or more modifications include at least one of a modification to a wavelength of electromagnetic radiation applied to the one or more samples, a modification to a duration that the electromagnetic radiation is applied to the one or more samples, or a modification to an intensity of electromagnetic radiation applied to the one or more samples.
